(19) United States
(12) Patent Application Publication
(10) Pub. No.: US 2018/0139975 A1
(43) Pub. Date: May 24, 2018

(54) METHODS AND DEVICE FOR CO-TREATMENT OF CROP PROTECTION CHEMICALS WITH PLANT GROWTH REGULATORS

(71) Applicant: AGROFRESH INC., Collegeville, PA (US)

(72) Inventors: Timothy Malefyt, Stroudsburg, PA (US); Daniel MacLean, Woodland, CA (US); Alastair S. Hill, Bellevue, WA (US)

(73) Assignee: AGROFRESH INC., Collegeville, PA (US)

(21) Appl. No.: 15/821,103

(22) Filed: Nov. 22, 2017

Related U.S. Application Data
(60) Provisional application No. 62/425,984, filed on Nov. 23, 2016.

(51) Int. Cl. A23B 7/152; A01N 43/36; A01N 55/08; A01N 43/54; A01N 43/78; A01N 25/00; A23L 3/3445

(52) U.S. Cl. CPC A23B 7/152; A01N 43/36; A01N 55/08; A23V 2002/00; A01N 43/78; A01N 25/00; A23L 3/3445; A01N 43/54

(57) ABSTRACT

The present disclosure relates to methods and a device for co-administering crop protection chemicals, such as pesticides and fungicides, with 1-MCP to inhibit plant pathogens and protect the quality of agricultural plants and crops, such as fruit.

### CROSS-REFERENCE TO RELATED APPLICATION

This application claims the benefit under 35 USC § 119(e) of U.S. Provisional Patent Application Ser. No. 62/425,984, filed on Nov. 23, 2016, the entire disclosure of which is incorporated herein by reference.

### FIELD OF THE PRESENT APPLICATION

The present application relates to methods and a device for co-treatment of crop protection chemicals with plant growth regulators (PGRs) to protect the quality of plant crops and to protect plant crops from plant pathogens.

### BACKGROUND

Post-harvest crop protection compounds or chemicals, such as pesticides, are traditionally applied to plants, seeds, and crops during sorting and packing operations, and are often applied using spraying and drenching methods. However, all crops are not amenable to spraying and drenching application methods of pesticides, particularly fungicides. For example, these particular pesticide application methods can be more difficult to control application rate, thereby contributing to the increase of fungicide-resistant pathogen populations in treated plant crops. Therefore, traditional methods of treating crops with fungicides are sometimes problematic, and alternative delivery methods of post-harvest fungicide treatments to plant crops are preferable.

Fogging treatments provide an alternative method of applying crop protection chemicals, such as pesticides, to plants and crops. Fogging pesticide treatments are typically administered to crops in a cold temperature, such as below room temperature. However, fogging application techniques are known to encounter problems with uniform distribution of active ingredient onto treated plant crops. For example, deposition rates of a fogging fungicide treatment may be too high, and exceed regulatory maximum residue limits, or too low, and fall below the minimum level required for efficacy. In contrast, the particle size of the fogging fungicide treatment may be too large causing the active ingredient to settle out of the fogging treatment prior to distribution onto the crops, and preventing uniform distribution of the active ingredient upon the fruit.

In addition, fogging operations are not typically performed successfully when cooling circulation fans are operating in a treatment room or a chamber, which is the case with traditional crop storage rooms, particularly fruit storage rooms. Fans are essential to the very important fruit cooling preservation process that occurs in storage rooms. Having fans off in the storage room during fungicide fogging operation is a negative feature of traditional application methods since the lack of air movement contributes to undesirable warming of the stored crop. The increased temperature consequently increases the rate of ripening and decay of the fruit during storage and/or transport. Accordingly, fungicide application efficacy is closely correlated to the uniformity of treatment distribution, particularly in a storage room. Ultimately, more uniformity and even distribution of crop protection chemicals, such as pesticide or fungicide treatments on the treated crops, improves the efficacy of such treatments on the inhibition and/or control of plant pathogens.

In addition to post-harvest plant, fruit, and vegetable pesticide treatments to inhibit plant pathogens, plants may be co-treated with plant growth regulators (PGRs). Plant growth regulators often comprise active ingredients to delay and/or inhibit plant crop growth, disorder, ripening, and/or maturation during storage and transport to retail sites. Cyclopropene is an organic compound that is known to have inhibitory effects on the ripening process of plants and agricultural or horticultural crops, such as fruit crops. For example, the cyclopropene derivative, 1-methylcyclopropene (1-MCP), is used by the commercial food industry to slow the ripening of fruits and vegetables due to exposure to ethylene.

However, there remains a need to efficiently employ post-harvest fogging methods to apply fungicide in combination with 1-MCP to plant crops in order to maximize crop protection from plant pathogens and from premature ripening during storage and transport. There is also a specific need to protect plants and crops from premature ripening and plant pathogens when they: 1) are not conducive to being treated in the field pre-harvest, 2) experience a delay in time required to transport crops from the field to a confined or an enclosed storage space, and/or 3) are stored in air tight confined/enclosed spaces, such as cold storage rooms.

The present disclosure describes methods and a device of administering crop protection chemicals, such as traditional pesticides, in non-traditional ways in order to protect crops from plant pathogens and premature ripening, to improve plant crop quality, and to extend plant shelf life. More specifically, the instant fogging device comprises a pesticide or a fungicide, such as fludioxonil, pyrimethanil, thiabendazole, or benzoxaborole, which is applied to plant crops in combination with a plant growth regulator, such as 1-MCP or diphenylamine (DPA). The co-treatment of the fungicide with the a plant growth regulator as described in the instant disclosure provides advantageous benefits over the prior art, including uniform distribution of the active ingredient upon the treated plant products, increased shelf life of the treated plant products, and improved protection of the plant products against fungal plant pathogens.

### SUMMARY OF THE INVENTION

The present disclosure provides a method of co-treating plants or plant parts. The method comprises placing the plants or plant parts in an enclosed space, and administering a co-treatment comprising a pesticide and a plant growth regulator to the plants or plant parts within the enclosed space. Finally, the method provides for inhibiting the plant pathogens and ethylene action of the plants or plant parts.

In the method described herein, the plants or plant parts may comprise fruit. In addition, the plant growth regulator is selected from the group consisting of 1-MCP and diphenylamine. The pesticide is selected from the group consisting of pyrimethanil, fludioxonil, thiabendazole, imazalil, and benzoxaborole. The pesticide of the present method may also be fludioxonil, benzoxaborole, pyrimethanil, or thiabendazole.

The 1-MCP of the present method is administered to the enclosed space as a gaseous composition. The pesticide of the present method is administered inside of the enclosed space, wherein the enclosed space is not ventilated. Further, the pesticide and plant growth regulator are administered to the plants or plant parts in the enclosed space simultaneously or concurrently.

The pesticide of the present method is also administered to the enclosed space as a fog. The fog of the present method comprises a plurality of microparticles. Each microparticle of the plurality of microparticles of the fog has a size of about 2 microns or less or of about 1 micron or less.

The present disclosure is also directed to a crop protection composition for treating plants or plant parts. The crop protection composition comprises a pesticide. The pesticide is a fog. The fog of the crop protection composition comprises a plurality of microparticles. Each microparticle of the plurality of microparticles of the fog has a size of about 2 microns or less, of about 1 micron or less, or less than 1 micron.

### BRIEF DESCRIPTION OF THE DRAWINGS

A brief description of the drawings is as follows.

FIG. 1 is a graph showing the fungal lesion diameter of Penicillium expansum and Botrytis cinerea (averaged together) on Golden Delicious apples treated on Days 0-2 with benzoxaborole, fludioxonil, pyrimethanil, thiabendazole, a propylene glycol negative control, or an untreated control.

FIG. 2 is a graph showing the fungal lesion diameter of Botrytis cinerea on Red Delicious apples treated on Days 0-3 with benzoxaborole, fludioxonil, pyrimethanil, thiabendazole, a propylene glycol negative control, or an untreated control.

FIG. 3 is a graph showing the fungal lesion diameter of Penicillium expansum on Red Delicious apples treated on Days 0-3 with benzoxaborole, fludioxonil, pyrimethanil, thiabendazole, a propylene glycol negative control, or an untreated control.

FIG. 4 is a graph showing the ethylene production of Golden Delicious apples 24 or 48 hours after the apples were treated with SmartFresh 1-MCP on Days 0-4 compared to Golden Delicious apples that were not treated at all with SmartFresh 1-MCP on Days 0-4 (untreated control).

FIG. 5 is a graph showing the ethylene production of Red Delicious apples 24 or 48 hours after the apples were treated with SmartFresh 1-MCP on Days 0-3 compared to Golden Delicious apples that were not treated at all with SmartFresh 1-MCP on Days 0-3 (untreated control).

### DETAILED DESCRIPTION

1. A method of co-treating plants or plant parts comprising:
placing the plants or plant parts in an enclosed space,
administering a co-treatment comprising a pesticide and a plant growth regulator to the plants or plant parts within the enclosed space, and
inhibiting plant pathogens and ethylene action of the plants or plant parts.

2. The method of clause 1, wherein the plants or plant parts comprise fruit.

3. The method of clause 1 or clause 2, wherein the fruit is an apple.

4. The method of clauses 1 to 3, wherein the apples are selected from the group consisting of Golden Delicious apples and Red Delicious apples.

5. The method of any one of clauses 1 to 4, wherein the plant growth regulator is administered to the enclosed space in a form selected from the group consisting of a liquid, a solid, and a gaseous composition.

6. The method of any one of clauses 1 to 5, wherein the plant growth regulator is administered to the enclosed space in a form of a gaseous composition.

7. The method of any one of clauses 1 to 6, wherein the pesticide is administered to the enclosed space as a fog.

8. The method of any one of clauses 1 to 7, wherein the pesticide is administered inside the enclosed space.

9. The method of any one of clauses 1 to 8, wherein the enclosed space is not ventilated.

10. The method of any one of clauses 1 to 9, wherein the pesticide and the plant growth regulator are administered to the plants or plant parts in the enclosed space simultaneously.

11. The method of any one of clauses 1 to 10, wherein the pesticide and the plant growth regulator are administered to the plants or plant parts in the enclosed space concurrently.

12. The method of any one of clauses 1 to 11, wherein the treatment time for the pesticide ranges from about 8 hours to about 24 hours.

13. The method of any one of clauses 1 to 12, wherein the treatment time for the plant growth regulator ranges from about 8 hours to about 24 hours.

14. The method of any one of clauses 1 to 13, wherein the plant growth regulator or the pesticide further comprise a carrier.

15. The method of any one of clauses 1 to 14, wherein the carrier is selected from the group consisting of liquids, gases, oils, solutions, solvents, solids, diluents, encapsulating materials, inclusion complexes, and chemicals.

16. The method of any one of clauses 1 to 15, wherein the liquid carrier comprises water, oil, buffer, saline solution, and a solvent.

17. The method of any one of clauses 1 to 16, wherein the co-treatment further comprises a component selected from the group consisting of adjuvants, surfactants, excipients, dispersants, antioxidants, emulsifiers, vitamins, minerals, and nutrients.

18. The method of any one of clauses 1 to 17, wherein the minerals and nutrients comprise calcium.

19. The method of any one of clauses 1 to 18, wherein the co-treatment is administered from a device.

20. The method of clause 19, wherein the device is located inside or outside of the enclosed space.

21. The method of clause 19, wherein the device is located inside of the enclosed space.

22. The method of clause 19, wherein the device is located outside of the enclosed space.

23. The method of any one of clauses 1 to 22, wherein the enclosed space has a headspace that ranges from about 200 cubic meters to about 10,000 cubic meters.

24. The method of any one of clauses 1 to 23, wherein the enclosed space is sealable or non-sealable.

25. The method of any one of clauses 1 to 24, wherein the enclosed space has a temperature ranging from about −1° C. to about 30° C.

26. The method of any one of clauses 1 to 25, wherein the enclosed space has a temperature of about 20° C.

27. The method of any one of clauses 1 to 26, wherein the enclosed space comprises an outlet, a portal or both.

28. The method of any one of clauses 1 to 27, wherein the enclosed space may or may not comprise a source of air flow.

29. The method of any one of clauses 1 to 28, wherein the source of air flow is one or more fans.

30. The method of any one of clauses 1 to 29, wherein the plant growth regulator or the pesticide are dispersed in the form of microparticles.

31. The method of any one of clauses 1 to 30, wherein each microparticle of the plurality of microparticles has a size of about 3 microns or less.

32. The method of any one of clauses 1 to 31, wherein each microparticle of the plurality of microparticles has a size of about 2 microns or less.

33. The method of any one of clauses 1 to 32, wherein each microparticle of the plurality of microparticles has a size of about 1 microns or less.

34. The method of any one of clauses 1 to 33, wherein each microparticle of the plurality of microparticles has a size of about less than 1 micron.

35. The method of any one of clauses 1 to 34, wherein the plant growth regulator is selected from the group consisting of a ripening inhibitor and an antioxidant.

36. The method of any one of clauses 1 to 35, wherein the plant growth regulator is a cyclopropene compound.

37. The method of any one of clauses 1 to 36, wherein the cyclopropene compound is 1-MCP.

38. The method of any one of clauses 1 to 37, wherein the 1-MCP has the structure or an analog or derivative thereof.

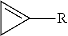

39. The method of any one of clauses 1 to 38, wherein the R is methyl.

40. The method of any one of clauses 1 to 39, wherein the concentration of 1-MCP ranges from about 10 ppb to about 100 ppm.

41. The method of any one of clauses 1 to 40, wherein the 1-MCP is administered via a route selected from the group consisting of release from a sachet, a synthetic or natural film, a liner or other packaging materials, a gas-releasing generator, compressed or non-compressed gas cylinder, dissolved in Supercritical CO₂ within a cylinder, a droplet inside a box, research tabs, and metal-organic frameworks.

42. The method of any one of clauses 1 to 35, wherein the plant growth regulator is an antioxidant.

43. The methods of any one of clauses 1 to 35 and clause 42, wherein the antioxidant is selected from the group consisting of N-Phenylaniline and diphenylamine.

44. The methods of any one of clauses 1 to 35 and clauses 42 to 43, wherein the antioxidant is diphenylamine.

45. The methods of any one of clauses 1 to 35 and clauses 43 to 44, wherein the diphenylamine has the structure

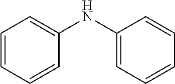 [SMILES: c1ccc(Nc2ccccc2)cc1]

or an analog or derivative thereof.

46. The method of any one of clauses 1 to 45, wherein the pesticide is a fungicide.

47. The method of clause 46, wherein the fungicide is selected from the group consisting of pyrimethanil, fludioxonil, thiabendazole, imazalil, and benzoxaborole compounds.

48. The method of clause 46, wherein the fungicide is fludioxonil.

49. The method of clause 48, wherein the fludioxonil is 4-(2,2-difluoro-benzo[1,3]dioxol-4-yl)pyrrole-3-carbonitrile or 4-(2,2-difluoro-1,3-benzodioxol-4-yl)-1H-pyrrole-3-carbonitrile.

50. The method of clause 48, wherein the fludioxonil has the structure

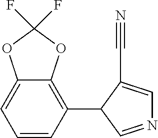 [SMILES: N#CC1=CN=CC1c1cccc2c1OC(F)(F)O2]

or an analog or derivative thereof.

51. The method of clause 46, wherein the fungicide is benzoxaborole.

52. The method of clause 51, wherein the benzoxaborole compound is selected from the group consisting of Compound A, Compound B, Compound C, and combinations thereof.

53. The method of clause 51 or clause 52, wherein the benzoxaborole compound is Compound A having the structure

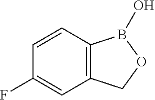 [SMILES: OB1OCc2cc(F)ccc21]

or an analog or a derivative thereof.

54. The method of clause 51 or clause 52, wherein the benzoxaborole compound is Compound B having the structure

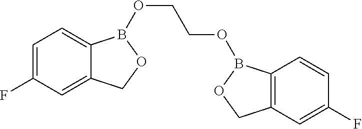 [SMILES: Fc1ccc2c(c1)COB2OCCOB1OCc2cc(F)ccc21]

or an analog or a derivative thereof.

55. The method of clause 51 or clause 52, wherein the benzoxaborole compound is Compound C having the structure

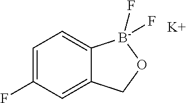 [SMILES: Fc1ccc2c(c1)CO[B-]2(F)F ; [K+]]

or an analog or a derivative thereof.

56. The method of clause 46, wherein the fungicide is pyrimethanil.

57. The method of clause 56, wherein the pyrimethanil is 4,6-Dimethyl-N-phenylpyrimidin-2-amine or 4, 6-Dimethyl-N-phenyl-2-pyrimidinamine.

58. The method of clause 56 or clause 57, wherein the pyrimethanil has the structure

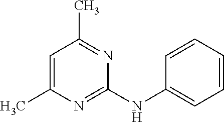

or an analog or derivative thereof.

59. The method of clause 46, wherein the fungicide is thiabendazole.

60. The method of clause 59, wherein the thiabendazole has the structure

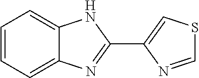 [SMILES: c1ccc2[nH]c(-c3cscn3)nc2c1]

or an analog or derivative thereof.

61. The method of clause 46, wherein the fungicide is imazalil.

62. The method of any one of clauses 1 to 61, wherein the plant growth regulator and the pesticide are applied in the form of a spray, a mist, a gel, a thermal and non-thermal fog, a dip, a drench, via sublimation, a vapor, or a gas.

63. The method of any one of clauses 1 to 62, wherein the pesticide and plant growth regulator are used in combination with an additional component selected from the group consisting of pesticides, minerals, nutrients, other plant growth regulators, chemicals, and a preservative gas.

64. The method of clause 63, wherein the preservative gas is carbon dioxide.

65. The method of clause 63, wherein the preservative gas is sulfur dioxide.

66. The method of any one of clauses 1 to 65, wherein the co-treatment is effective to inhibit growth of one or more plant pathogens.

67. The method of clause 66, wherein the one or more plant pathogens is a fungal pathogen.

68. The method of clause 67, wherein the fungal pathogen is selected from the group consisting of Acremonium spp., Albugo spp., Alternaria spp., Ascochyta spp., Aspergillus spp., Botryodiplodia spp., Botryospheria spp., Botrytis spp., Byssochlamys spp., Candida spp., Cephalosporium spp., Ceratocystis spp., Cercospora spp., Chalara spp., Cladosporium spp., Colletotrichum spp., Cryptosporiopsis spp., Cylindrocarpon spp., Debaryomyces spp., Diaporthe spp., Didymella spp., Diplodia spp., Dothiorella spp., Elsinoe spp., Fusarium spp., Geotrichum spp., Gloeosporium spp., Glomerella spp., Helminthosporium spp., Khuskia spp., Lasiodiplodia spp., Macrophoma spp., Macrophomina spp., Microdochium spp., Monilinia spp., Monilochaethes spp., Mucor spp., Mycocentrospora spp., Mycosphaerella spp., Nectria spp., Neofabraea spp., Nigrospora spp., Penicillium spp., Peronophythora spp., Peronospora spp., Pestalotiopsis spp., Pezicula spp., Phacidiopycnis spp., Phoma spp., Phomopsis spp., Phyllosticta spp., Phytophthora spp., Polyscytalum spp., Pseudocercospora spp., Pyricularia spp., Pythium spp., Rhizoctonia spp., Rhizopus spp., Sclerotium spp., Sclerotinia spp., Septoria spp., Sphaceloma spp., Sphaeropsis spp., Stemphyllium spp., Stilbella spp., Thielaviopsis spp., Thyronectria spp., Trachysphaera spp., Uromyces spp., Ustilago spp., Venturia spp., and Verticillium spp., and bacterial pathogens, such as Bacillus spp., Campylobacter spp., Clavibacter spp., Clostridium spp., Erwinia spp., Escherichia spp., Lactobacillus spp., Leuconostoc spp., Listeria spp., Pantoea spp., Pectobacterium spp., Pseudomonas spp., Ralstonia spp., Salmonella spp., Shigella spp., Staphylococcus spp., Vibrio spp., Xanthomonas spp., and Yersinia spp.

69. The method of clause 67 or clause 68, wherein the fungal pathogen is selected from the group consisting of Botrytis cinerea, Mucor piriformis, Fusarium sambucinum, Aspergillus brasiliensis, and Penicillium expansum.

70. The method of any one of clauses 67 to 69, wherein the fungal pathogen is Botrytis cinerea.

71. The method of any one of clauses 67 to 69, wherein the fungal pathogen is Penicillium expansum.

72. A crop protection composition for treating plants or plant parts comprising:

a pesticide, wherein the pesticide is a fog,
wherein the fog comprises a plurality of microparticles, wherein each microparticle of the plurality of microparticles has a size of about 3 microns or less.

73. The crop protection composition of clause 72, wherein each microparticle of the plurality of microparticles has a size of about 2 micron or less.

74. The crop protection composition of clause 72 or clause 73, wherein each microparticle of the plurality of microparticles has a size of about 1 micron or less.

75. The crop protection composition of any one of clauses 72 to 74, wherein each microparticle of the plurality of microparticles has a size that is less than 1 micron.

76. The crop protection composition of any one of clauses 72 to 75, wherein the size of the microparticles provides improvements of application of the crop protection composition onto plants or plant parts selected from the group consisting of ease of circulation in an enclosed space, uniform distribution of the active ingredient of the pesticide, no substantial wetting, and efficacious control and inhibition of plant pathogens.

77. The crop protection composition of any one of clauses 72 to 76, wherein the pesticide is a fungicide.

78. The crop protection composition of clause 77, wherein the fungicide is selected from the group consisting of pyrimethanil, fludioxonil, thiabendazole, imazalil, and benzoxaborole compounds.

79. The crop protection composition of clause 77 or clause 78, wherein the fungicide is fludioxonil.

80. The crop protection composition of clause 79, wherein the fludioxonil is 4-(2,2-difluoro-benzo[1,3]dioxol-4-yl)pyrrole-3-carbonitrile or 4-(2,2-difluoro-1,3-benzodioxol-4-yl)-1H-pyrrole-3-carbonitrile.

81. The crop protection composition of clause 79 or clause 80, wherein the fludioxonil has the structure

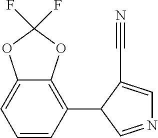 [SMILES: N#CC1=CN=CC1c1cccc2c1OC(F)(F)O2]

or an analog or derivative thereof.

82. The crop protection composition of clause 77, wherein the fungicide is benzoxaborole.

83. The crop protection composition of clause 82, wherein the benzoxaborole compound is selected from the group consisting of Compound A, Compound B, Compound C, and combinations thereof.

84. The crop protection composition of clause 82 or clause 83, wherein the benzoxaborole compound is Compound A having the structure

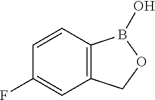 [SMILES: OB1OCc2cc(F)ccc21]

or an analog or a derivative thereof.

85. The crop protection composition of clause 82 or clause 83, wherein the benzoxaborole compound is Compound B having the structure

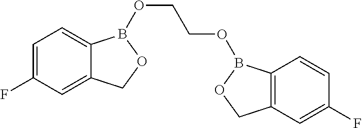 [SMILES: Fc1ccc2c(c1)COB2OCCOB1OCc2cc(F)ccc21]

or an analog or a derivative thereof.

86. The crop protection composition of clause 82 or clause 83, wherein the benzoxaborole compound is Compound C having the structure

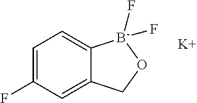 [SMILES: Fc1ccc2c(c1)CO[B-]2(F)F ; [K+]]

or an analog or a derivative thereof.

87. The crop protection composition of clause 77, wherein the fungicide is pyrimethanil.

88. The crop protection composition of clause 87, wherein the pyrimethanil is 4,6-Dimethyl-N-phenylpyrimidin-2-amine or 4, 6-Dimethyl-N-phenyl-2-pyrimidinamine.

89. The crop protection composition of clause 87 or clause 88, wherein the pyrimethanil has the structure

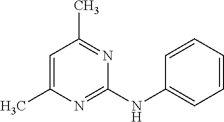

or an analog or derivative thereof.

90. The crop protection composition of clause 77, wherein the fungicide is thiabendazole.

91. The crop protection composition of clause 90, wherein the thiabendazole has the structure

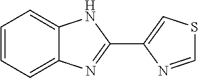 [SMILES: c1ccc2[nH]c(-c3cscn3)nc2c1]

or an analog or derivative thereof.

92. The crop protection composition of clause 77, wherein the fungicide is imazalil.

93. The crop protection composition of any one of clauses 72 to 92, further comprising an additional component selected from the group consisting of pesticides, minerals, nutrients, other plant growth regulators, chemicals, and a preservative gas.

94. The crop protection composition of clause 93, wherein the preservative gas is carbon dioxide.

95. The crop protection composition of clause 93, wherein the preservative gas is sulfur dioxide.

96. The crop protection composition of any one of clauses 72 to 95, wherein the composition is effective to inhibit growth of one or more plant pathogens.

97. The crop protection composition of clause 96, wherein the one or more plant pathogens is a fungal pathogen.

98. The crop protection composition of clause 97, wherein the fungal pathogen is selected from the group consisting of Acremonium spp., Albugo spp., Alternaria spp., Ascochyta spp., Aspergillus spp., Botryodiplodia spp., Botryospheria spp., Botrytis spp., Byssochlamys spp., Candida spp., Cephalosporium spp., Ceratocystis spp., Cercospora spp., Chalara spp., Cladosporium spp., Colletotrichum spp., Cryptosporiopsis spp., Cylindrocarpon spp., Debaryomyces spp., Diaporthe spp., Didymella spp., Diplodia spp., Dothiorella spp., Elsinoe spp., Fusarium spp., Geotrichum spp., Gloeosporium spp., Glomerella spp., Helminthosporium spp., Khuskia spp., Lasiodiplodia spp., Macrophoma spp., Macrophomina spp., Microdochium spp., Monilinia spp., Monilochaethes spp., Mucor spp., Mycocentrospora spp., Mycosphaerella spp., Nectria spp., Neofabraea spp., Nigrospora spp., Penicillium spp., Peronophythora spp., Peronospora spp., Pestalotiopsis spp., Pezicula spp., Phacidiopycnis spp., Phoma spp., Phomopsis spp., Phyllosticta spp., Phytophthora spp., Polyscytalum spp., Pseudocercospora spp., Pyricularia spp., Pythium spp., Rhizoctonia spp., Rhizopus spp., Sclerotium spp., Sclerotinia spp., Septoria spp., Sphaceloma spp., Sphaeropsis spp., Stemphyllium spp., Stilbella spp., Thielaviopsis spp., Thyronectria spp., Trachysphaera spp., Uromyces spp., Ustilago spp., Venturia spp., and Verticillium spp., and bacterial pathogens, such as Bacillus spp., Campylobacter spp., Clavibacter spp., Clostridium spp., Erwinia spp., Escherichia spp., Lactobacillus spp., Leuconostoc spp., Listeria spp., Pantoea spp., Pectobacterium spp., Pseudomonas spp., Ralstonia spp., Salmonella spp., Shigella spp., Staphylococcus spp., Vibrio spp., Xanthomonas spp., and Yersinia spp.

99. The crop protection composition of clause 97 or clause 98, wherein the fungal pathogen is selected from the group consisting of Botrytis cinerea, Mucor piriformis, Fusarium sambucinum, Aspergillus brasiliensis, and Penicillium expansum.

100. The crop protection composition of any one of clauses 97 to 99, wherein the fungal pathogen is Botrytis cinerea.

101. The crop protection composition of any one of clauses 97 to 99, wherein the fungal pathogen is Penicillium expansum.

102. The crop protection composition of any one of clauses 72 to 101, wherein the plants or plant parts comprise fruit.

103. The crop protection composition of clause 102, wherein the fruit is an apple.

104. The crop protection composition of clause 103, wherein the apple is selected from the group consisting of Golden Delicious apples and Red Delicious apples.

105. The crop protection composition of any one of clauses 72 to 104, wherein the pesticide is administered inside of an enclosed space.

106. The crop protection composition of clause 105, wherein the enclosed space is not ventilated.

107. The crop protection composition of any one of clauses 72 to 106, wherein the treatment time for the pesticide ranges from about 8 hours to about 24 hours.

108. The crop protection composition of any one of clauses 72 to 107, wherein the pesticide further comprises a carrier.

109. The crop protection composition of clause 108, wherein the carrier is selected from the group consisting of liquids, gases, oils, solutions, solvents, solids, diluents, encapsulating materials, inclusion complexes, and chemicals.

110. The crop protection composition of clause 109, wherein the liquid carrier comprises water, oil, buffer, saline solution, and a solvent.

111. The crop protection composition of any one of clauses 72 to 110, wherein the pesticide is applied to the plant or plant parts in the form of a spray, a mist, a gel, a thermal and non-thermal fog, a dip, a drench, via sublimation, a vapor, or a gas.

112. The crop protection composition of any one of clauses 72 to 111, further comprising a plant growth regulator.

113. The crop protection composition of clause 112, wherein the pesticide and the plant growth regulator are administered to the plants or plant parts in the enclosed space simultaneously.

114. The crop protection composition of clause 112 or clause 113, wherein the pesticide and the plant growth regulator are administered to the plants or plant parts in the enclosed space concurrently.

115. The crop protection composition of any one of clauses 112 to 114, wherein the plant growth regulator is selected from the group consisting of a ripening inhibitor and an antioxidant.

116. The crop protection composition of any one of clauses 112 to 115, wherein the ripening inhibitor is a cyclopropene compound.

117. The crop protection composition of any one of clauses 112 to 116, wherein the cyclopropene compound is 1-MCP.

118. The crop protection composition of any one of clauses 112 to 117, wherein the 1-MCP has the structure

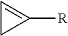

or an analog or derivative thereof.

119. The crop protection composition of any one of clauses 112 to 118, wherein the R is methyl.

120. The crop protection composition of any one of clauses 112 to 119, wherein the concentration of 1-MCP ranges from about 10 ppb to about 100 ppm.

121. The crop protection composition of any one of clauses 112 to 120, wherein the 1-MCP is administered via a route selected from the group consisting of release from a sachet, a synthetic or natural film, a liner or other packaging materials, a gas-releasing generator, compressed or non-compressed gas cylinder, dissolved in Supercritical CO₂ within a cylinder, a droplet inside a box, research tabs, and metal-organic frameworks.

122. The crop protection composition of clauses 112 to 115, wherein the plant growth regulator is an antioxidant.

123. The crop protection composition of clauses 112 to 115 and clause 122, wherein the antioxidant is selected from the group consisting of N-Phenylaniline and diphenylamine.

124. The crop protection composition of clauses 112 to 115 and clauses 122 to 123, wherein the antioxidant is diphenylamine.

125. The crop protection composition of clauses 112 to 115 and clauses 122 to 124, wherein the diphenylamine has the structure

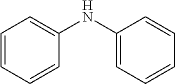 [SMILES: c1ccc(Nc2ccccc2)cc1]

or an analog or derivative thereof.

126. A device for administering the crop protection composition of clauses 72 to 125.

127. The device of clause 126, wherein the device is located inside or outside of an enclosed space.

128. The device of clause 126 or clause 127, wherein the device is located inside of the enclosed space.

129. The device of clause 126 or clause 127, wherein the device is located outside of the enclosed space.

130. The device of clauses 127 to 129, wherein the enclosed space has a headspace that ranges from about 200 cubic meters to about 10,000 cubic meters.

131. The device of clauses 127 to 130, wherein the enclosed space is sealable or non-sealable.

132. The device of clauses 127 to 131, wherein the enclosed space has a temperature ranging from about −1° C. to about 30° C.

133. The device of clauses 127 to 132, wherein the enclosed space has a temperature of about 20° C.

134. The device of clauses 127 to 133, wherein the enclosed space comprises an outlet, a portal or both.

135. The device of clauses 127 to 134, wherein the enclosed space may or may not comprise a fan.

The terms “plant(s),” “plant material(s),” “plant crops,” and “plant part(s)” include, but not limited to, whole plants, plant cells, and plant tissues, such as leaves, calli, stems, pods, roots, fruits, flowers, pollen, seeds, egg cells, zygotes, seeds, cell culture, tissue culture, or any other part or product of a plant. In one embodiment, plant material or plant part includes cotyledon and leaf. In another embodiment, plant material or plant part includes root tissues and other plant tissues located underground.

A class of plants that may be used in the present invention is generally as broad as the class of higher and lower plants including, but not limited to, dicotyledonous plants, monocotyledonous plants, agronomic crops, and horticultural crops. Agronomic crops include, but are not limited to, horticultural crops, and minimally-processed versions thereof. Horticultural crops of the present disclosure include, but are not limited to, vegetable crops, fruit crops, edible nuts, flowers and ornamental crops, nursery crops, aromatic crops, and medicinal crops. More specifically, horticultural crops of the present disclosure include, but are not limited to, fruits, vegetables, and ornamental plants.

A fruit of the present disclosure is selected from the group consisting of, but not limited to, almond, apple, avocado, banana, berries (including strawberry, blueberry, raspberry, blackberry, currants and other types of berries), carambola, cherry, citrus (including orange, lemon, lime, mandarin, grapefruit, and other citrus), coconut, fig, grape, guava, kiwifruit, mango, nectarine, melons (including cantaloupe, muskmelon, watermelon, honeydew, and other melons), olive, papaya, passionfruit, peach, pear, persimmon, pineapple, plum, pomegranate, and/or any combination thereof. In particular, pome fruits (e.g., apples and pears) and berries (e.g., strawberries, blackberries, blueberries, and raspberries), citrus, grapes, persimmons, and bananas are plants or plant crops encompassed by the present disclosure.

A vegetable of the present disclosure is selected from the group consisting of, but not limited to, asparagus, beet (including sugar and fodder beet), bean, broccoli, cabbage, carrot, cassava, cauliflower, celery, cucumber, eggplant, garlic, gherkin, leafy greens (lettuce, kale, spinach, and other leafy greens), leek, lentil, mushroom, onion, peas, pepper (sweet, bell or hot), potato, pumpkin, sweet potato, snap bean, squash, tomato, turnip, and/or any combination thereof.

Ornamental crops of the present disclosure are selected from the group consisting of, but not limited to, baby's breath, carnation, dahlia, daffodil, geranium, gerbera, lily, orchid, peony, Queen Anne's lace, rose, snapdragon, or other cut-flowers or ornamental flowers, potted flowers, flower bulbs, shrub, deciduous or coniferous tree, and/or any combination thereof. Nursery plant or flower or flower part of the present disclosure are selected from the group consisting of, but not limited to, rose, carnation, geranium, gerbera, lily, orchid, or other cut-flowers or ornamental flowers, flower bulbs, shrub, deciduous or coniferous tree, and/or any combination thereof.

Crops of the present disclosure may also include, but are not limited to, cereal and grain crops (e.g., corn, rice, and wheat), grain legume or pulses (e.g., beans and lentils), oilseed crops (e.g., soybean, sunflower, and canola), feed for industrial use, pasture and forage crops, fiber crops (e.g., cotton, flax, and hemp), sugar crops (e.g., sugar beets and sugarcane), and starchy root and tuber crops (e.g., beets, carrots, potatoes, and sweet potatoes). Crops of particular importance for the present invention include, but are not limited to, pome (e.g. apple and pear), citrus (e.g. orange), cucurbits (e.g. melons), corms and tubers (e.g., onions and potatoes), tropical (e g mango, papaya and avocado), and other crops that typically receive a post-harvest fungicide treatment (e.g., via spraying, dipping, or drenching) and/or are placed in short-term storage (e.g., hours to days) to long-term storage (e.g., months) prior to shipment or transport to retail sites. However, it should be noted that any variety or cultivar of berries, fruits, vegetables, or ornamental crops may be used in the present invention.

The phrases “enclosed space,” “confined space,” “bin,” and “chamber” refer to any defined space of the present disclosure in which a gas or a chemical can be introduced to a plant or food product, but from which the gas or the chemical cannot readily or easily escape once it has been introduced to the enclosed space or sealable chamber. For example, an enclosed space or sealable chamber may be made of plastic, glass, cellulosic material, cement, or any other semipermeable or impermeable material. An enclosed space, confined space, bin, or chamber of the present invention may further comprise a contained environment, which may be any contained volume of headspace within the enclosed space, confined space, bin, or chamber from which a gas, vapor, or chemical cannot readily escape once it has been introduced. An enclosed space, confined space, bin, or chamber of the present invention may be sealable to be made airtight and unsealable to allow air and gases to vent from the contained environment located within the enclosed space, confined space, bin, or chamber.

The terms “microorganism(s),” “plant pathogen(s),” or “fungal pathogen(s)” refer to organisms, such as Alternaria alternata, Aspergillus spp., Botrytis cinerea, Botryosphaeria dothidea, Diaporthe spp., Fusarium spp., Geotrichum spp., Glomerella spp., Lambertella cornimaris, Lasiodiplodia theobromae., Mucor piriformis, Neofabraea spp., Pectobacterium spp., Peniciliium spp., Phacidiopycnis spp., Phomopsis citrii., Phytophthora spp., Pseudomonas spp., Sclerotium spp., and Sphaeropsis pyriputrescens. Additional pathogens encompassed by the present invention include, but are not limited to Acremonium spp., Albugo spp., Alternaria spp., Ascochyta spp., Aspergillus spp., Botryodiplodia spp., Botryosphaeria spp., Botrytis spp., Byssochlamys spp., Candida spp., Cephalosporium spp., Ceratocystis spp., Cercospora spp., Chalara spp., Cladosporium spp., Colletotrichum spp., Cryptosporiopsis spp., Cylindrocarpon spp., Debaryomyces spp., Diaporthe spp., Didymella spp., Diplodia spp., Dothiorella spp., Elsinoe spp., Fusarium spp., Geotrichum spp., Gloeosporium spp., Glomerella spp., Helminthosporium spp., Khuskia spp., Lasiodiplodia spp., Macrophoma spp., Macrophomina spp., Microdochium spp., Monilinia spp., Monilochaethes spp., Mucor spp., Mycocentrospora spp., Mycosphaerella spp., Nectria spp., Neofabraea spp., Nigrospora spp., Penicillium spp., Peronophythora spp., Peronospora spp., Pestalotiopsis spp., Pezicula spp., Phacidiopycnis spp., Phoma spp., Phomopsis spp., Phyllosticta spp., Phytophthora spp., Polyscytalum spp., Pseudocercospora spp., Pyricularia spp., Pythium spp., Rhizoctonia spp., Rhizopus spp., Sclerotium spp., Sclerotinia spp., Septoria spp., Sphaceloma spp., Sphaeropsis spp., Stemphyllium spp., Stilbella spp., Thielaviopsis spp., Thyronectria spp., Trachysphaera spp., Uromyces spp., Ustilago spp., Venturia spp., and Verticillium spp., and bacterial pathogens, such as Bacillus spp., Campylobacter spp., Clavibacter spp., Clostridium spp., Erwinia spp., Escherichia spp., Lactobacillus spp., Leuconostoc spp., Listeria spp., Pantoea spp., Pectobacterium spp., Pseudomonas spp., Ralstonia spp., Salmonella spp., Shigella spp., Staphylococcus spp., Vibrio spp., Xanthomonas spp., and Yersinia spp.

### Compounds and Components of the Present Invention

The device and methods of the present disclosure are directed to administering a crop protection composition or compound, such as a pesticide, in combination with a plant growth regulator to treat horticultural plants and crops, such as fruit, vegetable, and ornamental crops. Any ingredient, chemical, or compound that is active as a pesticide and that can be formulated and/or delivered to a crop in an enclosed or outdoor space is within the scope of the present crop protection composition. Pesticides of the present disclosure include, but are not limited to herbicides, insecticides, acaricides, miticides, fungicides, and nematicides.

### Crop Protection Chemicals

Illustrative crop protection compounds, chemicals, or compositions of the present invention comprise pesticides. Exemplary pesticides of the present disclosure are fungicides, such as pyrimethanil, fludioxonil, thiabendazole, imazalil, and other commercially known pesticides. Additional classes of chemicals comprised in the pesticides of the present disclosure include, but are not limited to, oxaboroles (e.g., benzoxaborole) compounds.

Further, chemical pesticides that may be used in the present method include some that have been federally recognized. For example, Food, Drug and Cosmetic Act § § 201 and 409 Generally Recognized As Safe (GRAS) compounds and Federal Insecticide, Fungicide, and Rodenticide Act (FIFRA) § 25(b) chemicals, including eugenol, clove, thyme or mint oils, natural compounds, or compounds derived from natural sources may also be used in the present method. Illustrative embodiments of pesticides of the present disclosure are described as follows.

Pyrimethanil is a synthetic compound of the chemical group Anilinopyrimidine. Pyrimethanil is known to act as a pesticide, particularly a fungicide, to provide preventative and curative control of diseases of plants, seeds, and crops. One mechanism of action by which pyrimethanil has been shown to act as a fungicide is to inhibit methionine biosynthesis, and thus affects protein formation and subsequent cell division. Pyrimethanil has been shown to block the ability of fungi to degrade and digest plants, thereby inhibiting penetration and development of pathogenic disease and infection. Pyrimethanil has also been described as having a thermal decomposition temperature ranging from 189.54° C. to about 344.74° C. (Agriphar Pyrimethanil (ISO) Safety Data Sheet, revised Sep. 7, 2012, version 8.1).

An illustrative pesticide comprised in the device and methods of the present disclosure to treat plant or plant parts comprise, consist essentially of, or consist of pyrimethanil compounds. One exemplary embodiment of a pyrimethanil compound (4,6-Dimethyl-N-phenylpyrimidin-2-amine or 4, 6-Dimethyl-N-phenyl-2-pyrimidinamine) of the present invention is:

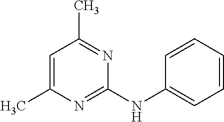

or an analog or derivative thereof.

Pyrimethanil is an active ingredient that may be used individually or as a mixture or combination with other compounds or carriers. The pyrimethanil compound may also be used in combination with preservative gases (e.g., carbon dioxide and sulfur dioxide), additional pesticides, minerals, nutrients, and plant growth regulators (e.g., ripening inhibitor) in order to form a pyrimethanil co-treatment. For example, minerals and nutrients (e.g., calcium) that reduce the incidence of bitter pit and other calcium related disorders are within the scope of the present pyrimethanil co-treatment. Other chemicals, components, or compounds comprising active ingredients may also be combined with the pyrimethanil compound in order to form a pyrimethanil co-treatment

In addition, pyrimethanil compound may also be used in combination with any carriers, coatings, solutions, solvents, additives, other chemicals, components, or compounds comprising inactive ingredients in order to form a pyrimethanil treatment. In particular, any and all inactive ingredients helpful to facilitate uniform delivery of technical pyrimethanil to plant crops via fogging application methods is comprised in the pyrimethanil treatment described herein. For example, the pyrimethanil compound may be used in combination with a biologically acceptable carrier to form a pyrimethanil treatment, such as a pyrimethanil fogging treatment. The pyrimethanil treatments and co-treatments described herein provide ripening inhibition and antimicrobial protection to plants or plant parts when administered, applied, or exposed to plants or plant parts.

Pyrimethanil may be used in any form, including, but not limited to, a solid (e.g., a powder), a gas, a vapor, or an aerosol composition. In particular, pyrimethanil may be used in the form of a gas, a fog, and/or a vapor, (“vapor”) when sufficient heat is applied to the solid pyrimethanil. In one embodiment, a pyrimethanil compound, one or more pyrimethanil compound, or a plurality of pyrimethanil compounds may be vaporized using heat to convert a solid to a liquid composition of pyrimethanil and then into a vapor or fog. In another embodiment, a pyrimethanil compound, one or more pyrimethanil compound, or a plurality of pyrimethanil compounds may be vaporized using heat to convert a solid composition of pyrimethanil into a vapor or a fog by sublimation. In an illustrative embodiment, a powder composition of pyrimethanil is heated in order to convert the solid composition directly into a vapor by sublimation.

Typically, at room temperature and lower, pyrimethanil exists as a solid as described in U.S. Provisional Patent Application No. 62/304,646, which is incorporated herein by reference. However, when the temperature increases, such as in response to heat, the solid pyrimethanil, alone or in suspension, volatilizes or vaporizes to become a gas, a fog, a vapor, or an aerosol (“vapor”). Heat may be applied to the pyrimethanil compound by any method that will cause the pyrimethanil to vaporize. However, in one embodiment of the present method, heat may be applied to the pyrimethanil compound using an apparatus or device. In an illustrative embodiment of the present method, a fogging device or apparatus is used to vaporize technical pyrimethanil for application to plant crops as a fog.

Benzoxaborole is another pesticide that has also been shown to have antimicrobial effects in plants, and is encompassed by the pesticide of the present disclosure (see U.S. Provisional Patent Application No. 62/304,636, which is incorporated herein by reference). Benzoxaboroles inhibit protein synthesis by blocking the leucine specific aaRS protein during translation. As an example, a benzoxaborole compound was proven to be effective as a volatile plant fungicide. The benzoxaborole compound of the present disclosure may be used individually or as a mixture or combination with other compounds or carriers.

The benzoxaborole compound may also be used in combination with preservative gases, additional pesticides, minerals, nutrients, and plant growth regulators (e.g., ripening inhibitor) to form a benzoxaborole co-treatment. For example, minerals and nutrients (e.g., calcium) that reduce the incidence of bitter pit and other calcium related disorders are within the scope of the present benzoxaborole co-treatment. Other chemicals, components, or compounds comprising active ingredients may also be combined with the benzoxaborole compound in order to form a benzoxaborole co-treatment

In addition, benzoxaborole compound may be used in combination with carriers, coatings, solutions, solvents, additives, other chemicals, components, or compounds comprising inactive ingredients in order to form a benzoxaborole treatment. In particular, any and all inactive ingredients helpful to facilitate uniform delivery of technical benzoxaborole compound to plant crops via fogging application methods is comprised in the benzoxaborole treatment described herein. For example, the benzoxaborole compound may be used in combination with a biologically acceptable carrier to form a benzoxaborole treatment, such as a benzoxaborole fogging treatment. The benzoxaborole treatments and co-treatments described herein provide ripening inhibition and antimicrobial protection to plants or plant parts when administered, applied, or exposed to plants or plant parts.

Exemplary embodiments of the benzoxaborole compounds of the present disclosure comprise Compounds A, B, and C, which may encompass diastereomers and enantiomers of the illustrative compounds. Enantiomers are defined as one of a pair of molecular entities which are mirror images of each other and non-superimposable. Diastereomers or diastereoisomers are defined as stereoisomers other than enantiomers. Diastereomers or diastereoisomers are stereoisomers not related as mirror images. Diastereoisomers are characterized by differences in physical properties.

One exemplary embodiment of a benzoxaborole compound of the present invention is Compound A:

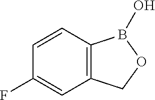 [SMILES: OB1OCc2cc(F)ccc21]

or an analog or derivative thereof. An additional illustrative embodiment of a benzoxaborole compound of the present invention is Compound B:

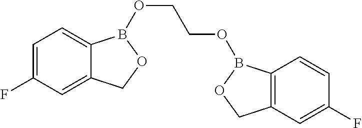 [SMILES: Fc1ccc2c(c1)COB2OCCOB1OCc2cc(F)ccc21]

or an analog or derivative thereof.

Another exemplary embodiment of a benzoxaborole compound of the present invention is Compound C, which is a salt version of Compounds A and/or B:

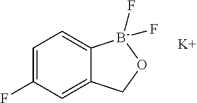 [SMILES: Fc1ccc2c(c1)CO[B-]2(F)F ; [K+]]

or an analog or derivative thereof.

Compounds A, B, and/or C may be used individually or as a mixture or combination. The benzoxaborole compounds may also be used in combination with preservative gases, such as carbon dioxide (CO₂) and sulfur dioxide (SO₂), or other chemicals to form a benzoxaborole treatment. The benzoxaborole treatment provides antimicrobial protection to plants or plant parts when administered, applied, or exposed to plants or plant parts.

Benzoxaborole Compounds A, B, and/or C may be used in any form, including, but not limited to, a liquid, a solid (e.g., a powder), or a gaseous composition. In particular, the present method provides application of a benzoxaborole compound as, for example, a spray, a mist, a gel, a thermal and non-thermal fog, a dip, a drench, via sublimation, a vapor, or a gas. Additional examples of benzoxaborole treatment administration include, but are not limited to, release from a sachet, a synthetic or natural film, a liner or other packaging materials, a gas-releasing generator, compressed or non-compressed gas cylinder, dissolved in Supercritical CO₂ within a cylinder, a droplet inside a box, or other similar methods as described in U.S. Pat. Nos. 8,669,207, 9,138,001, and 9,138,001, and U.S. Patent Publication No. 2014/0349853, which are incorporated herein by reference.

Fludioxonil is a synthetic compound of the chemical group Phenylpyrroles. Fludioxonil is known to act as a pesticide, particularly a fungicide, to provide preventative and curative control of diseases of plants, seeds, and crops. Two mechanisms of action by which fludioxonil have been shown to act as a fungicide is to inhibit glycerol synthesis and transport dependent phosphorylation of glucose. Fludioxonil has been shown to have a broad spectrum of activity, while also being non-systemic and offer long residual control for the prevention of seed and postharvest fruit diseases. Fludioxonil has also been described as having a thermal decomposition temperature starting at about 306° C. (Das, R (2000) Boiling point/boiling range of CGA 173506. Novartis Crop Protection Ltd., Basel, Switzerland. Unpublished report 80806 issued 3 Mar. 2000, Syngenta. Archive No CGA173506/5143.)

An illustrative pesticide comprised in the device and methods of the present disclosure to treat plant or plant parts comprise, consist essentially of, or consist of fludioxonil compounds. One exemplary embodiment of a fludioxonil compound (4-(2,2-difluoro-benzo[1,3]dioxol-4-yl)pyrrole-3-carbonitrile or 4-(2,2-difluoro-1,3-benzodioxol-4-yl)-1H-pyrrole-3-carbonitrile) of the present invention is:

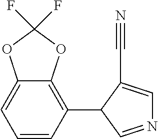 [SMILES: N#CC1=CN=CC1c1cccc2c1OC(F)(F)O2]

or an analog or derivative thereof.

Fludioxonil is an active ingredient that may be used individually or as a mixture or combination with other compounds or carriers. The fludioxonil compound may also be used in combination with preservative gases (e.g., carbon dioxide and sulfur dioxide), additional pesticides, minerals, nutrients, and plant growth regulators (e.g., ripening inhibitor) in order to form a fludioxonil co-treatment. For example, minerals and nutrients (e.g., calcium) that reduce the incidence of bitter pit and other calcium related disorders are within the scope of the presently claimed fludioxonil co-treatment. Other chemicals, components, or compounds comprising active ingredients may also be combined with the fludioxonil compound in order to form a fludioxonil co-treatment.

In addition, fludioxonil compound may also be used in combination with any carriers, coatings, solutions, solvents, additives, other chemicals, components, or compounds comprising inactive ingredients in order to form a fludioxonil treatment. In particular, any and all inactive ingredients helpful to facilitate uniform delivery of technical fludioxonil to plant crops via fogging application methods is comprised in the fludioxonil treatment described herein. For example, the fludioxonil compound may be used in combination with a biologically acceptable carrier to form a fludioxonil treatment, such as a fludioxonil fogging treatment. The fludioxonil treatments and co-treatments described herein provide ripening inhibition and antimicrobial protection to plants or plant parts when administered, applied, or exposed to plants or plant parts.

Fludioxonil may be used in any form, including, but not limited to, a solid (e.g., a powder), a gas, a vapor, or an aerosol composition. In particular, fludioxonil may be used in the form of a gas, a fog, and/or a vapor, (“vapor”) when sufficient heat is applied to the solid fludioxonil. In one embodiment, a fludioxonil compound, one or more fludioxonil compound, or a plurality of fludioxonil compounds may be vaporized using heat to convert a solid to a liquid composition of fludioxonil and then into a vapor or fog. In another embodiment, a fludioxonil compound, one or more fludioxonil compound, or a plurality of fludioxonil compounds may be vaporized using heat to convert a solid composition of fludioxonil into a vapor or a fog by sublimation. In an illustrative embodiment, a powder composition of fludioxonil is heated in order to convert the solid composition directly into a vapor by sublimation.

Typically, at room temperature and lower, fludioxonil exists as a solid. However, when the temperature increases, such as in response to heat, the solid fludioxonil, alone or suspension, volatilizes or vaporizes to become a gas, a fog, a vapor, or an aerosol (“vapor”). Heat may be applied to the fludioxonil compound by any method that will cause the fludioxonil to vaporize. However, in one embodiment of the present method, heat may be applied to the fludioxonil compound using an apparatus or device. In an illustrative embodiment of the present method, a fogging device or apparatus is used to vaporize technical fludioxonil for application to plant crops as a fog.

Thiabendazole is a synthetic compound of the chemical group Benzimidazoles. Thiabendazole is known to act as a pesticide, particularly a fungicide, to provide control of diseases of plants, seeds, and crops. One mechanism of action by which thiabendazoles have been shown to act as a fungicide is to inhibit beta-tubulin assembly during mitosis. Thiabendazole has been shown to control a variety of fruit and vegetable diseases that are caused by various fungi, especially those causing postharvest fruit diseases. Thiabendazole has also been described as having a melting point starting at about 304° C. to about 305° C. (O'Neil, M. J. (ed.). The Merck Index—An Encyclopedia of Chemicals, Drugs, and Biologicals. Whitehouse Station, N.J.: Merck and Co., Inc., 2006., p. 1597.)

An illustrative pesticide comprised in the device and methods of the present disclosure to treat plant or plant parts comprise, consist essentially of, or consist of thiabendazole compounds. One exemplary embodiment of a thiabendazole compound (4-(1H-1,3-Benzodiazol-2-yl)-1,3-thiazole) of the present invention is:

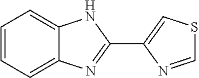 [SMILES: c1ccc2[nH]c(-c3cscn3)nc2c1]

or an analog or derivative thereof.

Thiabendazole is an active ingredient that may be used individually or as a mixture or combination with other compounds or carriers. The thiabendazole compound may also be used in combination with preservative gases (e.g., carbon dioxide and sulfur dioxide), additional pesticides, minerals, nutrients, and plant growth regulators (e.g., ripening inhibitor) in order to form a thiabendazole co-treatment. For example, minerals and nutrients (e.g., calcium) that reduce the incidence of bitter pit and other calcium related disorders are within the scope of the presently claimed thiabendazole co-treatment. Other chemicals, components, or compounds comprising active ingredients may also be combined with the thiabendazole compound in order to form a thiabendazole co-treatment

In addition, thiabendazole compound may also be used in combination with any carriers, coatings, solutions, solvents, additives, other chemicals, components, or compounds comprising inactive ingredients in order to form a thiabendazole treatment. In particular, any and all inactive ingredients helpful to facilitate uniform delivery of technical thiabendazole to plant crops via fogging application methods is comprised in the thiabendazole treatment described herein. For example, the thiabendazole compound may be used in combination with a biologically acceptable carrier to form a thiabendazole treatment, such as a thiabendazole fogging treatment. The thiabendazole treatments and co-treatments described herein provide ripening inhibition and antimicrobial protection to plants or plant parts when administered, applied, or exposed to plants or plant parts.

Thiabendazole may be used in any form, including, but not limited to, a solid (e.g., a powder), a gas, a vapor, or an aerosol composition. In particular, thiabendazole may be used in the form of a gas, a fog, and/or a vapor, (“vapor”) when sufficient heat is applied to the solid or liquid thiabendazole formulation. In one embodiment, a thiabendazole compound, one or more thiabendazole compound, or a plurality of thiabendazole compounds may be vaporized using heat to convert a solid to a liquid composition of thiabendazole and then into a vapor or fog. In another embodiment, a thiabendazole compound, one or more thiabendazole compound, or a plurality of thiabendazole compounds may be vaporized using heat to convert a solid composition of thiabendazole into a vapor or a fog by sublimation. In an illustrative embodiment, a powder composition of thiabendazole is heated in order to convert the solid composition directly into a vapor by sublimation.

Typically, at room temperature and lower, thiabendazole exists as a solid. However, when the temperature increases, such as in response to heat, the solid thiabendazole, alone or in suspension, volatilizes or vaporizes to become a gas, a fog, a vapor, or an aerosol (“vapor”). Heat may be applied to the thiabendazole compound by any method that will cause the thiabendazole to vaporize. However, in one embodiment of the present method, heat may be applied to the thiabendazole compound using an apparatus or device. In an illustrative embodiment of the present method, a fogging device or apparatus is used to vaporize technical thiabendazole for application to plant crops as a fog.

Plant Growth Regulators

Plant growth regulators (PGRs) of the present disclosure include, but are not limited to, active ingredients that regulate and/or cause any effect on the growth, disorders, maturation, and/or ripening of plants and plant crops. Illustrative embodiments of the PGR of the present disclosure comprise a component, compound, or composition that may act as an inhibitor of ripening, maturation, growth, senescence, decay, disorder, coloration, and/or infection in plants and plant crops. An exemplary PGR of the claimed invention is a ripening inhibitor or an antioxidant.

An illustrative ripening inhibitor of the claimed invention is a cyclopropene compound. The cyclopropene compound of the present disclosure to treat plant or plant parts comprise, consist essentially of, or consist of the cyclopropene derivative, 1-methylcyclopropene (1-MCP) compounds. 1-methylcyclopropene (1-MCP) is used by the commercial food industry to slow the ripening of fruits and vegetables due to exposure to ethylene. Ethylene is a gas that is known to stimulate or regulate plants processes, including the ripening of fruits. 1-MCP binds to the ethylene receptor and blocks ethylene from initiating and/or speeding the ripening process in fruits, and thus delays or prevents the natural ripening process.

Exemplary embodiments of the cyclopropene compounds of the present disclosure comprise at least one 1-methylcyclopropene (1-MCP) compound, which may encompass diastereomers and enantiomers of the illustrative compounds. Enantiomers are defined as one of a pair of molecular entities which are mirror images of each other and non-superimposable. Diastereomers or diastereoisomers are defined as stereoisomers other than enantiomers. Diastereomers or diastereoisomers are stereoisomers not related as mirror images. Diastereoisomers are characterized by differences in physical properties.

One exemplary embodiment of a 1-MCP compound of the present invention is:

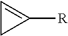

or an analog or derivative thereof. In an exemplary embodiment, R is methyl. 1-MCP may be used individually or as a mixture or combination with another compound or carrier. For example, the 1-MCP compound may also be used in combination with a carrier to form a 1-MCP treatment.

The 1-MCP compound may also be used in combination with preservative gases (e.g., carbon dioxide (CO₂) and sulfur dioxide (SO₂)), additional pesticides, minerals, nutrients, other plant growth regulators, other chemicals, components, or compounds comprising active ingredients in order to form a 1-MCP co-treatment. In addition, 1-MCP compound may also be used in combination with carriers, coatings, solutions, solvents, additives, other chemicals, components, or compounds comprising inactive ingredients in order to form a 1-MCP treatment. For example, the 1-MCP compound may be used in combination with a biologically acceptable carrier to form a 1-MCP treatment. The 1-MCP treatments and co-treatments described herein provide ripening inhibition and antimicrobial protection to plants or plant parts when administered, applied, or exposed to plants or plant parts.

The 1-MCP active ingredient in the treatment of the present disclosure comprises, consists of, or consists essentially of about 0.001% to about 50% active ingredient in the product. In addition, the typical concentration of 1-MCP in an enclosed space or chamber in which plants or plants parts (e.g., fruits and vegetables) may be treated ranges from about 10 ppb to about 100 ppm, from about 20 ppb to about 75 ppm, 30 ppb to about 50 ppm, from about 40 ppb to about 25 ppm, from about 50 ppb to about 10 ppm, from about 75 ppb to about 15 ppm, from about 100 ppb to about 5 ppm, from about 250 ppb to about 15 ppm, from about 10 ppb to about 5 ppm, from about 25 ppb to about 50 ppm, and at or about 1 ppm.

1-MCP may be used and/or delivered in any form, including, but not limited to, a liquid, a solid (e.g., a powder), or a gaseous composition. In particular, the present method provides application of a 1-MCP compound as a spray, a mist, a gel, a thermal and non-thermal fog, a dip, a drench, via sublimation, a vapor, or a gas. In an exemplary application, 1-MCP gaseous treatment is delivered into the enclosed space or chamber comprising plants or fruit crops. The 1-MCP treatment provides protection to plants or crops from premature ripening when the treatment is administered, applied, or exposed to the plant or crops.

Additional examples of 1-MCP treatment administration encompassed by the present invention include, but are not limited to, release from a sachet, a synthetic or natural film, a liner or other packaging materials, a gas-releasing generator, compressed or non-compressed gas cylinder, a droplet inside a box, research tabs, release from other encapsulation methods (e.g., metal-organic framework or MOF), or other similar methods. An illustrative embodiment of 1-MCP mode of administration is performed using a 1-MCP gas-releasing generator device. Further, any and all commercial formulations and/or delivery modes of 1-MCP treatment are encompassed by the present invention, including but not limited to, SmartFresh, ProTabs, SmartTabs, Harvista, etc.

An illustrative disorder inhibitor of the claimed invention is an antioxidant. An illustrative antioxidant of the claimed invention comprises an N-Phenylaniline or diphenylamine compound. The diphenylamine compound of the present disclosure to treat plant or plant parts comprise, consist essentially of, or consist of the N-Phenylaniline derivative, diphenylamine (DPA) compounds. Diphenylamine (DPA) is used by the commercial food industry as a postharvest plant growth regulator to control storage scald (e.g. superficial scald), which is a disorder of fruit that particularly affects apples.

One exemplary embodiment of a DPA compound of the present invention is:

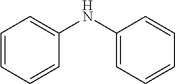 [SMILES: c1ccc(Nc2ccccc2)cc1]

or an analog or derivative thereof. DPA may be used individually or as a mixture or combination with another compound or carrier. For example, the DPA compound may also be used in combination with a carrier to form a DPA treatment.

The DPA compound may also be used in combination with preservative gases (e.g., carbon dioxide (CO₂) and sulfur dioxide (SO₂)), additional pesticides, minerals, nutrients, other plant growth regulators, other chemicals, components, or compounds comprising active ingredients in order to form a DPA co-treatment. In addition, DPA compound may also be used in combination with carriers, coatings, solutions, solvents, additives, other chemicals, components, or compounds comprising inactive ingredients in order to form a DPA treatment. For example, the DPA compound may be used in combination with a biologically acceptable carrier to form a DPA treatment. The DPA treatments and co-treatments described herein provide scald control and protection to plants or plant parts when administered, applied, or exposed to plants or plant parts.

The DPA active ingredient in the treatment of the present disclosure comprises, consists of, or consists essentially of about 0.1% to about 50% active ingredient in the product. DPA may be used and/or delivered in any form, including, but not limited to, a liquid, a solid (e.g., a powder), or a gaseous composition. In particular, the present method provides application of a DPA compound as a spray, a mist, a gel, a thermal and non-thermal fog, a dip, a drench, via sublimation, a vapor, a fog, or a gas. In an exemplary application, DPA gaseous treatment is delivered into the enclosed space or chamber comprising plants or fruit crops.

The DPA treatment provides protection to plants or crops from storage scald when the treatment is administered, applied, or exposed to the plant or crops. The present disclosure describes methods and a device of co-treating agricultural and horticultural plants and crops with a pesticide in combination with a plant growth regulator, such as a ripening inhibitor or an antioxidant. More specifically, the present disclosure provides methods and a device for co-treating post-harvest plant crops with a fogging composition comprising a crop protection chemical, such as a fungicide. Illustrative embodiments of the pesticide or fungicide of the present disclosure include, but are not limited to fludioxonil, pyrimethanil, thiabendazole, and benzoxaborole, or any combination thereof.

The pesticides (e.g., fungicides) of the present invention are administered in combination with a plant growth regulator, such as a ripening inhibitor or an antioxidant. An exemplary ripening inhibitor of the present disclosure includes, but is not limited tol-MCP. An illustrative antioxidant of the present disclosure includes, but is not limited to DPA.

Any combination and/or mixture of crop protection chemicals and/or plant growth regulators (PGRs) is encompassed within the scope of the present disclosure. Illustrative and exemplary treatments of active ingredients described in the present disclosure comprise, for example, 1) fludioxonil, 2) benzoxaborole, 3) pyrimethanil, 4) thiabendazole, and 5) 1-methylcyclopropene. Illustrative and exemplary co-treatments of active ingredients described in the present disclosure comprise, for example, 1) pyrimethanil and 1-methylcyclopropene, 2) fludioxonil and 1-methylcyclopropene, 3) benzoxaborole and 1-methylcyclopropene, 4) thiabendazole and 1-methylcyclopropene, and 5) pyrimethanil, fludioxonil, benzoxaborole, thiabendazole, and 1-methylcyclopropene, and any combinations thereof. Thus, the present disclosure provides methods and a device to deliver pesticide treatments and co-treatments to protect plants from plant pathogens and premature ripening during storage or transport in order to extend the shelf life of treated plant products and maximize their economic value.

In addition to the advantageous ability to deliver pesticides and PGRs to plant crops in combination, the device and methods of the present disclosure are also capable of delivering essential oils and additional active ingredients to plant crops. Essential oils and active ingredients delivered by the device and method of the present disclosure may be derived from natural plant sources. Thus, essential oils and active ingredients of the present invention comprise extracts from an organism selected from the group consisting of Achillea spp., Amomum spp., Anethum spp., Asteraceae spp., Borago spp., Brassica spp., Bulnesia spp., Calamus spp., Camellia spp., Cananga spp., Capsicum spp., Cassia spp., Cedrus spp., Chamaecyparis spp., Chrysopogon spp., Cinnamomum spp., Citrus spp., Coriandrum spp., Cupressus spp., Curcuma spp., Cymbopogon spp., Dianthus spp., Dipterocarpus spp., Elettaria spp., Eucalyptus spp., Forniculum spp., Gaultheria spp., Geranium spp., Glycine spp., Gossypium spp., Iris spp., Jasmineae spp., Juniperus spp., Lavandula spp., Linum spp., Lippia spp., Litsea spp., Melaleuca spp., Mentha spp., Myristica spp., Ocimum spp., Ornothera spp., Origanum spp., Pimenta spp., Pimpinella spp., Pinus spp., Piper spp., Pogostemon spp., Ricinus spp., Rosa spp., Rosmarinus spp., Salvia spp., Santalum spp., Sassafras spp., Secale spp., Sesamum spp., Simmondsia spp., Syringa spp., Syzygium spp., Thuja spp., Thymus spp., Trigonella spp., Vanilla spp., Zea spp., Zingiber spp, and combinations or mixtures thereof.

Moreover, active ingredients of the present invention derived from natural plant sources include, but are not limited to allyl disulfide, allyl sulfide, amyl cinnamic aldehyde, alpha-phellandrene, amyl cinnamic aldehyde, amyl salicylate, anethole, trans-anethole, anisic aldehyde, 4-anisaldehyde, benzaldehyde, benzyl acetate, benzyl alcohol, bergamot, bicyclogermacrene, borneol, bornyl acetate, 2-butene, alpha-butylene, D-cadinene, calamenene, alpha-campholenic aldehyde, camphor, caryophyllene, caryophyllene oxide, trans-caryophyllene, carvacrol, carveol, 4-carvomenthenol, carvone, cineole, 1,4-cineole, 1,8-cineole, cinnamaldehyde, hexyl-cinnamaldehyde, trans-cinnamaldehyde, cinnamic alcohol, alpha-cinnamic terpinene, alpha-isoamyl-cinnamic, cinnamyl alcohol, citral, citric acid, citronella and oil, citronellal, hydroxy citronellal, citronellol, alpha-citronellol, citronellyl acetate, citronellyl nitrile, corn gluten meal, coumarin, cuminaldehyde, p-cymene, decanal, trans-2-decenal, decyl aldehyde, diethyl phthalate, dihydroanethole, dihydrocarveol, dihydrocarvone, dihydrolinalool, dihydromyrcene, dihydromyrcenol, dihydromyrcenyl acetate, dihydroterpineol, dimethyl salicylate, cis-3,7-dimethyl-1,6-octadien-3yl acetate, cis-3,7-dimethyl-2,6-octadien-1-ol, dimethyloctanal, dimethyloctanol, dimethyloctanyl acetate, dimethyl salicylate, dimethyl thiophene, diphenyl oxide, dipropylene glycol, dodecanal, estragole, ethyl vanillin, eucalyptol, eugenol, eugenyl acetate, farnesol, fenchol, ferniol, furfural, galaxolide, geraniol, geranyl acetate, geranyl nitrile, globulol, guaiacol, gurjunene, heliotropin, herbanate, 1-hexanol, hexanal, trans-2-hexen-1-al, alpha-humulene, hydrogen peroxide, ionone, isoamyl isovalerate, isobutyl quinoleine, isobornyl acetate, isobornyl methylether, isobutyric anhydride, isoeugenol, isolongifolene, isosafrole, isothiocyanate, jasmonic acid, lauryl sulfate, lavandin, limonene, linalool oxide, linalool, linalyl acetate, longifolene, malic acid, menthe, menthane hydroperoxide, menthol, menthyl acetate, menthofurane, menthol, menthone, methional, methyl acetate, methyl anthranilate, methyl cedryl ketone, methyl chavicol, methyl cinnamate, methyl cyclopropane, methyl eugenol, methyl hexyl ether, methyl ionone, methyl jasmonate, 1-methyl-4-isopropyl-1-cyclohexen-8-ol, methyl salicylate, 3-methyl thiopropionaldehyde, muscone, musk xylol, myrcene, neral, nerol, neryl acetate, 2-nonanone, nonyl aldehyde, trans-beta-ocimene, palustrol, perillaldehyde, petitgrain, alpha-phellandrene, p-hydroxy phenyl butanone, phenyl ethyl alcohol, phenyl ethyl propionate, phenyl ethyl-2-methylbutyrate, cis-pinane, pinane hydroperoxide, pinanol, pine ester, alpha-pinene, alpha-pinene oxide, beta-pinene, piperonal, piperonyl acetate, piperonyl alcohol, plinol, plinyl acetate, potassium sorbate, 2-propanol, 2-propenyl methyl disulphide, 1-proponyl methyl disulphide, pseudoionone, pulegone, rhodinol, rhodinyl acetate, rosalin, rosemarinic acid, safrole, salicylaldehyde, sandenol, sodium chloride, sodium lauryl sulfate, sotolon, spathulenol, spirantol, terpenoid, terpineol, alpha-terpineol, terpine-4-ol, alpha-terpinene, gamma-terpinene, terpinolene, terpinyl acetate, tert-butylcyclohexyl acetate, tetrahydrolinalool, tetrahydrolinalyl acetate, tetrahydromyrcenol, alpha-beta-thuj one, thymol, turpentine, undecanoic acid, 10-undecenoic acid, vanillin, and verbenone. In a further embodiment, the active ingredient of the present disclosure is a compound selected from a group consisting of metal chlorites, chlorates, carbonates, and metal metabisulfite.

Treatments and Co-Treatments

The application timing of crop protection (e.g., pesticide or fungicide) treatments and co-treatments to plant crops may occur simultaneously and concurrently. For example, the pesticide and the 1-MCP of an illustrative embodiment of the present co-treatment may be used to treat plant crops or applied to plant crops at the same time or at different times. In particular, the present co-treatment provides for simultaneous and concurrent administration of the pesticide and the plant growth regulator.

An exemplary embodiment of the present pesticide co-treatment is to simultaneously or concurrently apply a pesticide, such as a fungicide (e.g., pyrimethanil, fludioxonil, thiabendazole, or benzoxaborole), in combination with 1-MCP, to plant crops such that some portion of the pesticide and PGR treatment times overlap. A treatment time for the present invention is a time period wherein plants and plant products, such as fruits and vegetable, are treated with an active compound of the present disclosure (i.e., a pesticide and/or a plant growth regulator). The treatment time of the present disclosure comprises an application time and an exposure time. Typically, the treatment time is the sum total of the application time and the exposure time.

The application time for an active compound, treatment, or co-treatment of the present disclosure is the time period that the compound, treatment, or co-treatment is released from its respective receptacle, container, and/or device, and is administered to the enclosed space. For example, the application time of a pesticide of the present disclosure is the time period in which the pesticide is actually administered from a fogging device to the enclosed space containing plants, fruits, or vegetables to be treated.

An illustrative embodiment of the application time of the present pesticide ranges from about 15 minutes to about 8 hours, and any time therein, including but not limited to, from about 15 minutes to about 7 hours, from about 15 minutes to about 7 hours, from about 15 minutes to about 6 hours, from about 15 minutes to about 5 hours, from about 15 minutes to about 4 hours, from about 30 minutes to about 7 hours, from about 30 minutes to about 7 hours, from about 30 minutes to about 6 hours, from about 30 minutes to about 5 hours, from about 30 minutes to about 4 hours, from about 1 hour to about 7 hours, from about 1 hour to about 7 hours, from about 1 hour to about 6 hours, from about 1 hour to about 5 hours, and from about 1 hour to about 4 hours. An exemplary embodiment of the fogging device and/or modified fogging device of the present invention may be located within the enclosed space during the application time. In contrast, an exemplary embodiment of the application time of 1-MCP must be at least about 24 hours, and typically ranges from about 24 hours to about 48 hours, from about 24 hours to about 72 hours, or from about 24 hours to about 96 hours.

The exposure time for an active compound, treatment, or co-treatment of the present disclosure is the time period that the compound, treatment, or co-treatment is exposed to the plants, fruits, or vegetables being treated in order to have optimal efficacy. Exposure during the exposure time includes any form of contact between the compound, treatment, or co-treatment and the products (e.g., plants, fruits, or vegetables) being treated. For example, the exposure time of a pesticide of the present disclosure is the time period that the pesticide remains in the enclosed space after being applied (i.e., during the application time) in order to optimally and efficaciously treat products. Accordingly, the exposure time is the length of time, occurring immediately after the completion of the application time, in which plants, fruits, or vegetables are exposed to the active compound, treatment, or co-treatment within the enclosed space.

An illustrative embodiment of the exposure time of the present pesticide is at least about 8 hours, about 8 hours or more, and typically ranges from about 8 hours to about 48 hours, from about 8 hours to about 72 hours, or from about 8 hours to about 96 hours. In contrast, an exemplary embodiment of the exposure time of the 1-MCP is at least about 8 hours, about 8 hours, about 8 hours or more, and typically ranges from about 24 hours to about 48 hours, from about 24 hours to about 72 hours, or from about 24 hours to about 96 hours.

The treatment time, including the application time and the exposure time, of the pesticide and PGR co-treatment may occur simultaneously. Simultaneous treatment time of the pesticide and the PGR occurs when both the application time of the pesticide overlaps completely with the application time of the PGR and/or the exposure time of the pesticide overlaps completely with the exposure time of the PGR. For the present disclosure, the complete overlap of treatment time also includes circumstances where the full application time of the pesticide occurs within the application time period of the PGR, or vice versa. For example, the application time of the pesticide completely overlaps with the application time of the PGR when the pesticide application time is 6 hours of the 24 hours of 1-MCP application time. Similarly, the complete overlap of treatment time may also include circumstances where the full exposure time of the pesticide occurs within the exposure time of the PGR, or vice versa. For example, the exposure time of the pesticide completely overlaps the exposure time of the PGR when the pesticide exposure time is 8 hours of the 24 hours of 1-MCP exposure time.

Treatment times of the pesticide and PGR co-treatment may also occur concurrently. Concurrent treatment time of the pesticide and the PGR occurs when any portion of the application time of the pesticide overlaps with any portion of the application time of the PGR and/or any portion of the exposure time of the pesticide overlaps with any portion of the exposure time of the PGR. In other words, treatment times occur concurrently when any portion of the application time or the exposure time of the pesticide and the PGR overlap. For example, the application time of the pesticide and the PGR may overlap only by about 30 seconds or less, about 1 minute, about 5 mins, about 30 mins, about 1 hour, about 3 hours, or about 6 hours or more. Similarly, the exposure time of the pesticide and the PGR may overlap only by about 30 seconds, about 1 minute, about 5 mins, about 30 mins, about 1 hour, about 3 hours, or about 6 hours. In addition, concurrent treatment time of the pesticide and the PGR occurs when both the application time of the pesticide overlaps at all with the application time of the PGR and the exposure time of the pesticide overlaps at all with the exposure time of the PGR. Finally, concurrent treatment time occurs when any portion of the application time of the pesticide overlaps with any portion of the exposure time of the PGR and vice versa, such as when any portion of the exposure time of the pesticide overlaps with any portion of the application time of the PGR.

Carriers of the present disclosure are materials or compositions involved in carrying or transporting an active ingredient, compound, composition, analog, or derivative from one location to another location. Carriers may be combined with active ingredients, such as pyrimethanil, fludioxonil, thiabendazole, benzoxaborole, and/or 1-MCP compounds, or combinations thereof, to form a treatment or a co-treatment. Treatment carriers of the present disclosure may comprise liquids, gases, oils, solutions, solvents, solids, diluents, encapsulating materials, inclusion complexes, or chemicals. For example, a liquid carrier of the present disclosure may comprise water, oil, buffer, saline solution, a solvent, etc.

In addition to carriers, other components may be comprised in the treatments and co-treatments of the present disclosure including, but not limited to, adjuvants, surfactants, excipients, dispersants, antioxidants, emulsifiers, vitamins, minerals, nutrients, etc. In particular, minerals and nutrients that may assist crop preservation during storage, such as a topical application of calcium, are also within the scope of the presently claimed treatment carriers.

The active compounds, treatments, and co-treatments of the present invention may be applied to plants, plant crops, or plant parts located inside or outside a volume of any enclosed space or chamber. The present invention may be efficaciously administered from a device located outside of an enclosed space or sealable chamber to plants or plant crops that are located inside the enclosed space or sealable chamber. Importantly, the present invention may be administered from a device located inside of an enclosed space or a chamber to plants or plant crops that are also located inside the enclosed space or the chamber. This capability of the present invention to administer the treatments and co-treatments inside the enclosed space, and particularly without ventilation, is an improvement over the prior art.

Prior art methods of applying fogging pesticides by locating the fogging device outside an enclosed space or sealable chamber to plant crops located inside the enclosed space or chamber. The fog from prior art fogging devices, located outside of the sealed chamber, was funneled into the sealed chamber containing the fruit. This fog funneling process also introduced air into the sealed chamber. The additional air in the chamber diluted the active pesticide concentration within the space, reduced efficacy of the treatment, and also required ventilation. Importantly, ventilation has a negative effect on the proper administration of the PGR. Thus, the prior art methods were unable to successfully treat plant crops contained within an enclosed space or chamber with a device located inside of the enclosed space or chamber, as can the present invention. This is an improvement over the prior art.

The enclosed space or sealable chamber of the present disclosure may be of any size that is large enough to hold plants and plant parts to be treated. Typically, the enclosed space of the present invention is stationary and is not readily portable or mobile. For example, an enclosed space of the present invention may be a large storage room (e.g., a gymnasium size) having a headspace of several hundred to several thousand cubic meters. Thus, an exemplary enclosed space of the present invention may have a headspace size ranging from 200 to about 10,000 cubic meters, from about 200 to about 8000 cubic meters, from about 200 to about 7500 cubic meters, from about 200 to about 5000 cubic meters, from about 200 to about 3000 cubic meters, and about 2000 cubic meters. Illustrative embodiments of the enclosed space of the present disclosure may comprise space selected from the group consisting of normal refrigerated storage rooms, controlled atmosphere storage rooms, citrus degreening rooms, fruit ripening rooms (e.g., for bananas and tomatoes), sorting line fog tunnels, short-term storage rooms, inside pallet wraps, and small dedicated treatment rooms. Further, gymnasiums, barns, and other large industrial storage facilities are within the scope of the enclosed space of the present disclosure.

In contrast, the active compounds (e.g., pyrimethanil, fludioxonil, thiabendazole, benzoxaborole, and/or 1-MCP), treatments, and co-treatments of the present disclosure may be applied to plants or crops, such as fruit crops in a volume of a chamber or a bin. A chamber or a bin of the present disclosure may be any container and may be sealable or non-sealable. A chamber or a bin of the present disclosure may be stationary, portable, or mobile, such that it may be transported with or without plant crops located inside.

The chamber or bin of the present disclosure may be made of any material to hold fruit. For example, a chamber or bin may be made of plastic, wood, glass, or any other semipermeable or impermeable material. Illustrative embodiments of the bin or chamber of the present disclosure include, but are not limited to a wagon, a transport truck cargo area, a cold-storage room, a marine container, an air container, a train car or local vehicle, a transport truck, a truck trailer, a box, a pallet, a pallet-wrap, a grain silo, an intermodal container, a temporary, permanent, or semi-permanent tent, and/or other types of containers used for transportation or temporary storage of plants and plant crops.

The bin or chamber described herein may be of any size that is large enough to hold plants or crops to be treated. For example, an exemplary chamber or bin may have a volume or capacity of about 50 to about 2000 pounds (lbs.), from about 150 lbs. to about 1750 lbs., from about 300 lbs. to about 1500 lbs., from about 500 lbs. to about 1250 lbs., from about 750 lbs. to about 1100 lbs., from about 800 lbs. to about 1000 lbs., from about 850 lbs. to about 1000 lbs., and at about 900 lbs. or about 950 lbs. An illustrative chamber may have a headspace size ranging from 0.5 cubic meters to about 150 cubic meters or about 200 cubic meters.

The enclosed space or chamber is typically held at a temperature suitable for cold storage of plant crops, such as fruits, flowers, or vegetables. For example, the temperature of the enclosed space or chamber may range from about −1° C. to about 35° C., including from about −1° C. to about 30° C., from about −1° C. to about 25° C., from about −1° C. to about 20° C., from about −1° C. to about 15° C., from about −1° C. to about 10° C., from about −1.5° C. to about 35° C. from about −1.5° C. to about 30° C., from about −1.5° C. to about 25° C., from about −1.5° C. to about 20° C., from about −1.5° C. to about 15° C., and from about −1.5° C. to about 10° C. The enclosed space or chamber may also comprise, consist of, or consist essentially of different environments or atmospheres in which the plants or fruit crops are exposed. For example, an enclosed space or chamber may comprise a controlled environment and/or refrigerated temperatures of about 4° C. or lower (e.g., 0° C.).

In addition, a chamber may comprise a controlled atmosphere that is flooded with nitrogen (N₂) in order to reduce oxygen (O₂) levels in the chamber. Alternatively, the fruit may be exposed to a regular atmosphere, wherein the environment is not controlled. For example, a regular atmosphere typically comprises refrigerated temperatures of about 0° C. to 4° C., and an environment that has about 21% oxygen (O₂), about 78% nitrogen, and about 0.1% carbon dioxide (CO₂). Finally, fruit may be exposed to warm room days wherein the fruit are removed from the cool temperatures of the controlled and/or regular atmospheres and brought into spaces at room temperature where fruit may be assessed for quality and ripeness.

The enclosed space or chamber described herein may have a port (e.g., a bulkhead septum port) for the introduction or release of the chemical treatments and co-treatments released as a vapor, a fog, or an aerosol. The contained environment of the enclosed space or chamber may also comprise an outlet or a portal. The portal of the enclosed space or chamber may be used to apply the pesticide treatment, co-treatment to plant crops held within the space or chamber. The outlet may be used to vent or release air, gases, or unused portions of the treatment, co-treatment, or treatment carrier. Accordingly, the outlet may be used to maintain atmospheric pressure of the space or chamber. The outlet and the portal may also be one in the same sealable opening in the enclosed space or chamber.

Fogging devices distribute and disperse active microparticles of pesticide or fungicide throughout the enclosed space or chamber aided by the source of air flow and movement that may be present in the space or chamber (e.g., fans). In particular, the delivery of a pesticide fog in combination with 1-MCP helps uniformly distribute the 1-MCP gas throughout the room even in the absence of fans for improved efficacy in plant protection. This was a surprising result from the combinatorial and/or synergistic effect of the pesticide and 1-MCP of the present invention.

The size of the microparticles of the fogging pesticide treatments and co-treatments described herein may range from about 3 microns or less, from about less than 3 microns, about 3 microns, from about 2 microns or less, from about less than 2 microns, about 2 microns, from about less than 1 micron (submicron size), about 1 micron or less, 1 micron, from about 0.1 micron to about 1 micron, from about 0.2 micron to about 1 micron, from about 0.3 micron to about 1 micron, from about 0.4 micron to about 1 micron, from about 0.5 micron to about 1 micron, from about 0.6 micron to about 1 micron, from about 0.7 micron to about 1 micron, from about 0.8 micron to about 1 micron, from about 0.9 micron to about 1 micron, and about 1 micron. The submicron size of the microparticles of the present pesticide treatments and co-treatments described herein may also range from about 0.1 micron to about 0.9 micron, from about 0.2 micron to about 0.8 micron, from about 0.3 micron to about 0.7 micron, from about 0.4 micron to about 0.6 micron, from about 0.2 micron to about 0.6 micron, from about 0.2 micron to about 0.9 micron, from about 0.2 micron to about 0.6 micron, from about 0.2 micron to about 0.7 micron, from about 0.2 micron to about 0.5 micron, from about 0.2 micron to about 0.4 micron, from about 0.2 micron to about 0.3 micron, from about 0.5 micron or less, from about less than 0.5 micron, and about 0.5 micron.

Prior art fogging applications use particle sizes ranging from about 3 microns to about 10 microns. The extremely small to submicron size of the active microparticles of the present fogging pesticide composition and method enables uniform and even distribution and dispersion of the active ingredient for improved efficacy of fungicide or pesticide treatments of plants and plant parts over prior art methods. The combinatorial effect of the small pesticide particle size of the fog with the 1-MCP gas provides surprisingly improved effects over the prior art.

In particular, the smaller microparticles of the present invention are much more easily circulated and distributed in a storage room or chamber with fans, while fans cannot be used in some prior art fogging methods. In particular, the delivery of smaller pesticide fog microparticles in combination with 1-MCP helps uniformly distribute the 1-MCP throughout the storage room even in the absence of fans. Moreover, the small microparticles of the present fogging method enable uniform distribution of the active ingredient on the plants or plant parts without substantial wetting, such as with water or a solvent. Thus, the present method provides a unique way of treating plants and plant parts without substantially wetting the fruit, but still enabling uniform application and efficacious disease control and inhibition of plant pathogens in the absence of fans. Wetting of fruit encourages pathogen spread, spore germination, and disease infestation.

Accordingly, the present disclosure describes methods and a device of administering traditional pesticides and plant growth regulators, such as ripening inhibitors, in non-traditional ways for use in antimicrobial protection of crops to inhibit plant pathogens and premature ripening, and to extend plant shelf life. The present disclosure describes methods and a device of co-treating agricultural and horticultural plants and crops with a co-treatment comprising a pesticide combined with a ripening inhibitor, such as 1-MCP. More specifically, the present disclosure provides methods and a device for co-treating post-harvest plant crops with a fogging composition comprising a fungicide, such as pyrimethanil or benzoxaborole with 1-MCP. Thus, the present disclosure provides methods and a device to protect plants from plant pathogens and protect plants from premature ripening during storage or transport in order to extend the shelf life of treated plant products and maximize their economic value.

The post-harvest fogging treatment device and methods of the present disclosure provide advantageous benefits over prior art devices and methods. In particular, the instant fogging device comprises a fungicide, such as pyrimethanil or benzoxaborole, which is applied to plant crops in combination with a ripening inhibitor, such as 1-MCP. The co-treatment of the fungicide and 1-MCP of the instant disclosure provides uniform distribution of the active ingredient (i.e., fungicide and/or 1-MCP) upon the treated plant products and increasing shelf life of the treated products, while protecting the plants against plant pathogens. As compared to prior art treatments, the treatment and co-treatment device and methods of the instant disclosure promote the uniform distribution of active ingredient on the plant crops by comprising: 1) smaller fogging formulation particle size, 2) improved uniformity of distribution on fruit, and 3) capability for use in a sealed space without venting or ventilation of the space. Further, the device and methods of the present disclosure will not exceed the maximum or minimum residue limits for efficacy of the active ingredient(s), which means that the compositions may be used domestically and also safely shipped abroad.

The device and methods described herein provide new treatment options and application systems to preserve the freshness of pre-harvest or post-harvest plants and crops by delaying premature ripening and protecting the plants and crops against plant pathogens. Furthermore, the device and methods of the present disclosure advantageously protect plants and crops that are not conducive to being treated in the field pre-harvest, waiting for the time required to transport fruit from the field to a confined space, and/or being stored in confined spaces. Ultimately, the device and methods described herein provide beneficial co-treatment delivery options for established pesticides and in combination with plant growth regulator application systems.

Device for Administering Crop Protection Chemicals

In one embodiment of the present method, a crop protection chemical, such as a pesticide (e.g., a fungicide), may be applied to plants or crops using an apparatus or device. In an illustrative embodiment of the present device, a commercially-available fogging device has been modified, improved, and implemented for a specific purpose in the present method. Internal and external modifications (e.g., orientation) to the commercial fogging device were incorporated to generate a modified fogging device of the present disclosure.

Modifications to the commercial fogger device that enabled practice of the present invention includes new washer and bushing specifications, compressed air addition to permit a remote post-fogging clean out procedure, an enclosure to protect components from fog deposition, and a remote monitor to initiate and terminate a fogging operation from outside the enclosed space or chamber wherein treatment occurs. The modified fogging device as described herein was used to apply a fogging treatment comprising a fungicide, such as pyrimethanil, fludioxonil, thiabendazole, or benzoxaborole, to plants or plant crops in combination with the application of 1-MCP or DPA.

The modified fogging device may push the active pesticide compound out of its orifice(s) and directly into an enclosed space or chamber. The device may also penetrate the chamber or space and may be sealed therein, such that a significant amount of active ingredient is not lost to the environment via ventilation, but is applied directly to the enclosed space or chamber instead. The chamber or space may comprise plants or plant parts, such as fruits, flowers, or vegetables, to be treated with the active pesticide in order to control plant pathogens.

The present invention may be administered from a modified fogging device located inside of an enclosed space or chamber to plants or plant crops that are located outside of the enclosed space or sealable chamber. For example, a co-treatment of fungicide and 1-MCP could be administered pre-harvest from a small shelter or building in a field or orchard to plants and crops growing in the field or orchard. Accordingly, the present invention may be applied to plant crops both pre-harvest and post-harvest. Alternate pre-harvest fogging methods of the present invention include use of the present method or device in-field and for application of the treatment to a bin of plant crops or products located in the field.

The modified fogging device of the present disclosure is also capable of treating plants post-harvest when located inside and outside an enclosed space or chamber. More specifically, the device of the present invention is capable of applying efficacious fogging pesticide treatments to plant crops located within an enclosed space or chamber when the device is also located inside the enclosed space or chamber during treatment. Thus, there is no need to vent the instant pesticide fogging treatment from the enclosed space or chamber. For example, a device of the present invention may be located within an enclosed space or chamber comprising the plant crops to be treated and provide efficacious protection to the treated plant products within the space or chamber against plant pathogens without the need to vent the space or chamber. Accordingly, the claimed device and methods provides and improvement and unexpected results over the prior art.

The size of the microparticles of the present fogging device for application of pesticide treatments and co-treatments described herein may range from about 3 microns or less, from about less than 3 microns, about 3 microns, from about 2 microns or less, from about less than 2 microns, about 2 microns, from about less than 1 micron (submicron size), about 1 micron or less, 1 micron, from about 0.1 micron to about 1 micron, from about 0.2 micron to about 1 micron, from about 0.3 micron to about 1 micron, from about 0.4 micron to about 1 micron, from about 0.5 micron to about 1 micron, from about 0.6 micron to about 1 micron, from about 0.7 micron to about 1 micron, from about 0.8 micron to about 1 micron, from about 0.9 micron to about 1 micron, and about 1 micron. The submicron size of the microparticles of the present fogging device for application of pesticide treatments and co-treatments described herein may also range from about 0.1 micron to about 0.9 micron, from about 0.2 micron to about 0.8 micron, from about 0.3 micron to about 0.7 micron, from about 0.4 micron to about 0.6 micron, from about 0.2 micron to about 0.6 micron, from about 0.2 micron to about 0.9 micron, from about 0.2 micron to about 0.6 micron, from about 0.2 micron to about 0.7 micron, from about 0.2 micron to about 0.5 micron, from about 0.2 micron to about 0.4 micron, from about 0.2 micron to about 0.3 micron, from about 0.5 micron or less, from about less than 0.5 micron, and about 0.5 micron.

Prior art fogging devices use particle sizes ranging from about 3 microns to about 10 microns. The extremely small to submicron size of the active microparticles of the present fogging pesticide device enables uniform and even distribution and dispersion of the active ingredient for improved efficacy of fungicide or pesticide treatments of plants and plant parts over prior art methods. In addition, the smaller particle size helps lower risk of exceeding maximum residue limits, while simultaneously increasing the likelihood of achieving enough residues for a biological response

In particular, the smaller fogging microparticles of the present device are much more easily circulated and distributed in a storage room or chamber with fans, while fans cannot be used in some prior art fogging methods comprising larger particle sizes. Moreover, the small microparticles of the present fogging device enables uniform distribution of the active ingredient (i.e., fungicide and/or 1-MCP) on the plants or plant parts without substantial wetting, such as with water or a solvent. Thus, the present device provides a unique way of treating plants and plant parts without substantially wetting the fruit, but still enabling uniform application and efficacious disease control and inhibition of plant pathogens.

Any plants or plant parts (e.g., flowers), plant cells, or plant tissues may be treated using the present method. A class of plants that may be treated in the present invention is generally as broad as horticultural crops. Horticultural crops, include, but are not limited to, vegetable crops, fruit crops, edible nuts, flowers and ornamental crops, nursery crops, aromatic crops, and medicinal crops. More specifically, fruits (e.g., grapes, apples, oranges, pears, persimmons, and bananas) and berries (e.g., strawberries, blackberries, blueberries, and raspberries) are plants encompassed by the present disclosure. It should be noted that any species of berries or fruits may be used in the present invention (e.g., Table grapes).

### Methods of Administering Treatments and Co-Treatments

The present disclosure is directed to methods of administering a treatment and/or a co-treatment to plants and plant crops, wherein the co-treatment comprises a pesticide in combination with a plant growth regulator. One embodiment of a method of the present disclosure is directed to a method of delivering a co-treatment to plants and plant crops, wherein the co-treatment comprises a pesticide in combination with a plant growth regulator. Another embodiment of the present invention is a method of co-treating plants and plant crops with a pesticide in combination with a plant growth regulator. A further embodiment of the claimed invention is a method for increasing the uniformity and distribution of 1-MCP treatment. A method of inhibiting plant pathogens and/or for inhibiting the premature ripening of plant crops is described herein.

Pesticide with or without 1-MCP treatment methods may be applied to the plants or crops described herein inside of an enclosed space, a bin, or a chamber. The chamber may be open or closed/sealed during application of the pesticide and 1-MCP co-treatment. Typically, the plants or crops, such as fruit crops are manually or robotic ally placed in the chamber, and the chamber may optionally be sealed. The pesticide treatment is then applied to the chamber comprising the plants or crops, such as fruit crops using the device described herein. The 1-MCP treatment is also applied to the chamber comprising the plants and plant crops. However, the application and or exposure of the crop protection chemical (e.g., pesticide) and the plant growth regulator to plants or plant parts in any order (e.g., pesticide first and PGR last or PGR first and pesticide last) is within the scope of the present invention.

The treatment time, including the application time and the exposure time, for pesticide (e.g., fungicide) treatment and co-treatment methods to plant crops may occur simultaneously and/or concurrently with the application timing of the 1-MCP (as described above in the Treatments and Co-Treatments section). For example, the pesticide and the 1-MCP of an illustrative embodiment of the present co-treatment method may be applied to plant crops at the same time or at different times such that some portion (i.e., any portion) of the application and/or exposure times of the crop protection compound (e.g., the pesticide) and the plant growth regulator (e.g., 1-MCP or DPA) overlap.

An exemplary embodiment of the present crop protection compound co-treatment is to apply a pesticide, such as a fungicide (e.g., pyrimethanil, fludioxonil, thiabendazole, or benzoxaborole) with a plant growth regulator (PGR), such as 1-MCP. The pesticide and PGR may be applied onto plant crops simultaneously, such that the pesticide and PGR treatment application times and/or exposure times overlap completely. An additional embodiment of the present pesticide co-treatment is to apply a pesticide (e.g., pyrimethanil, fludioxonil, thiabendazole, or benzoxaborole) with 1-MCP to plant crops concurrently, such that some portion of the pesticide and PGR treatment application times and/or exposure times overlap.

### Examples

Illustrative embodiments of the methods of the present disclosure are provided herein by way of examples. While the concepts and technology of the present disclosure are susceptible to broad application, various modifications, and alternative forms, specific embodiments will be described here in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

It is standard practice in the industry to treat plants and fruits with agents to prevent and/or inhibit their decay or degradation due to antimicrobial growth (e.g., a pesticide or fungicide). It is also routine for plants and crops to be treated with plant growth regulator compounds to prevent and/or inhibit their natural ripening process (e.g., 1-MCP). Typically in industry practice, 1-MCP is applied to plants or crops within a few days to a few weeks of harvest, while application of a pesticide or fungicide follows. The following experiments were conducted to determine the efficacy and outcome of rapid or early treatment of plants and/or crops with a pesticide (e.g., a fungicide) and a plant growth regulator (e.g., 1-MCP).

### Example 1: Rapidity of Fungicide Treatment of Fungal Growth Inhibition on Golden Delicious Apples

Freshly harvested plants and crops, such as fruit crops (e.g. apple fruits), were wounded and inoculated with fungal pathogens. Immediately after harvest on Day 0, Golden Delicious apples were wounded on the left and/or the right sides of the fruit. The wounds were immediately inoculated with one or more fungal strains. For example, the wounds on the left side of the fruit were inoculated with Penicillium, while the wounds on the right side of the fruit were inoculated with Botrytis. After inoculation, the apples remained at 20° C. throughout the remainder of the experimental trial.

Inoculated fruits were separated in preparation for an experimental trial that comprised three replicates of 10-fruit cohorts each totaling 5.1 kg of Golden Delicious apples (see Table 1). After inoculation, the apples were held at 20° C. in a closed, controlled environment until fungicide treatment. Prior to fungicide treatment, a fruit cohort was removed from the controlled environment and transported to a sealed treatment chamber having a temperature of 20° C. The fruit cohorts were each treated with a single respective fungicide on Day 0 (i.e., day of harvest), as well as Days 1, 2, 3, and/or 4 after harvest (see Table 2).

More specifically, each fruit cohort was treated a single time for 24 hours with a specific fungicide solution comprising the following active ingredients: benzoxaborole (BOB), thiabendazole (TBZ), pyrimethanil (PYR), and fludioxonil (FDL) as described in Table 1 below. The fungicide solutions used to treat inoculated apples comprised the following concentration of active ingredients: a 100 g/L of benzoxaborole (BOB), thiabendazole (TBZ), and fludioxonil (FDL), or a 160 g/L of pyrimethanil (PYR), respectively (see Table 1).

Inoculated fruits were also treated with a propylene glycol-inoculated negative control (GLY IC). This propylene glycol-inoculated control treatment comprised only propylene glycol, a common fungicide treatment carrier, with no active ingredient (see Table 1). In addition, another cohort of inoculated fruits was not treated with a fungicide at all to produce an untreated inoculated control (UNTRT IC).

In this trial, replicate cohorts of Golden Delicious apples were treated by fogging with 167 μL of the benzoxaborole (BOB) solution, 270 μL of the thiabendazole (TBZ) solution, 410 μL of the pyrimethanil (PYR) solution, or 170 μL of the fludioxonil (FDL) solution, respectively (see Table 1). The fungicide fogging treatment was applied to the Golden Delicious apples in the sealed treatment chamber comprising a volume of 1.1 m³ such that the final concentration of active ingredient (“ai”) of each fungicide applied to the Golden Delicious apples during the trial was 3.3 mg/kg of benzoxaborole (BOB), 8.0 mg/kg of thiabendazole (TBZ) solution, 8.5 mg/kg of pyrimethanil (PYR) solution, and 3.3 mg/kg of fludioxonil (FDL), respectively (see Table 1).

After 24 hours of fungicide treatment in the sealed chamber at 20° C., treated apples were returned back to the closed, controlled environment for storage. Storage of treated fruit occurred for at least 12 hours and for up to approximately 72 hours until Day 3 or Day 4 when fungal lesions on the treated fruit were measured (see Table 2). For example, inoculated fruit cohorts treated with fungicide on Day 0, where returned to the control chamber on Day 1 and stored there for at least 12 hours (e.g., approximately 48-72 hours) until their fungal lesions were measured on Days 3 or 4 (see Table 2). Inoculated fruit cohorts treated with fungicide on Day 1, where returned to the control chamber on Day 2 and stored there for at least 12 hours (e.g., approximately 24-48 hours) until their fungal lesions were measured on Days 3 or 4 (see Table 2).

TABLE 1

| | Golden Delicious Trial | | | | | Red Delicious Trial | | | | |
|---|---|---|---|---|---|---|---|---|---|---|
| | Treatment active^{a} | | | | | | | | | |
| | BOB | TBZ | PYR | FDL | GLYIC | BOB | TBZ | PYR | FDL | GLYIC |
| Solution | 100 | 100 | 160 | 100 | NA | 100 | 100 | 160 | 100 | NA |
| active | | | | | | | | | | |
| (g/l) | | | | | | | | | | |
| Solution | 167 | 270 | 410 | 170 | NA | 250 | 620 | 410 | 250 | NA |
| fogged | | | | | | | | | | |
| (μl) | | | | | | | | | | |
| Active | 3.3 | 8.0 | 8.5 | 3.3 | NA | 4.6 | 11.2 | 11.8 | 4.6 | NA |
| ingredient | | | | | | | | | | |
| (ai) | | | | | | | | | | |
| applied | | | | | | | | | | |
| (mg/kg) | | | | | | | | | | |
| Fruit | 5.1 | 5.1 | 5.1 | 5.1 | 5.1 | 5.5 | 5.5 | 5.5 | 5.5 | 5.1 |
| treated | | | | | | | | | | |
| (kg) | | | | | | | | | | |
| Volume | 1.1 | 1.1 | 1.1 | 1.1 | 1.1 | 1.1 | 1.1 | 1.1 | 1.1 | 1.1 |
| fogged | | | | | | | | | | |
| (m³) | | | | | | | | | | |

TABLE 2

| | Day 0 | Day 1 | Day 2 | Day 3 | Day 4 |
|---|---|---|---|---|---|
| Fungicide | All Fruits- | Day 0 | Day 1 | Day 2 | Day 3 |
| Fogging | harvested, | Fruit | Fruit | Fruit | Fruit |
| Experiment | wounded, | Stored | Stored | Stored | Stored |
| Treatment | & inoculated | Day 1 | Day 2 | Day 3 | Days 0-3 |
| Regimen | Day 0 | Fruit | Fruit | Fruit | Fruit |
| for Red and | Fruit | Treated | Treated | Treated | Measured |
| Golden | Treated | | | Days 0-3 | |
| Delicious | | | | Fruit | |
| Apples | | | | Measured | |

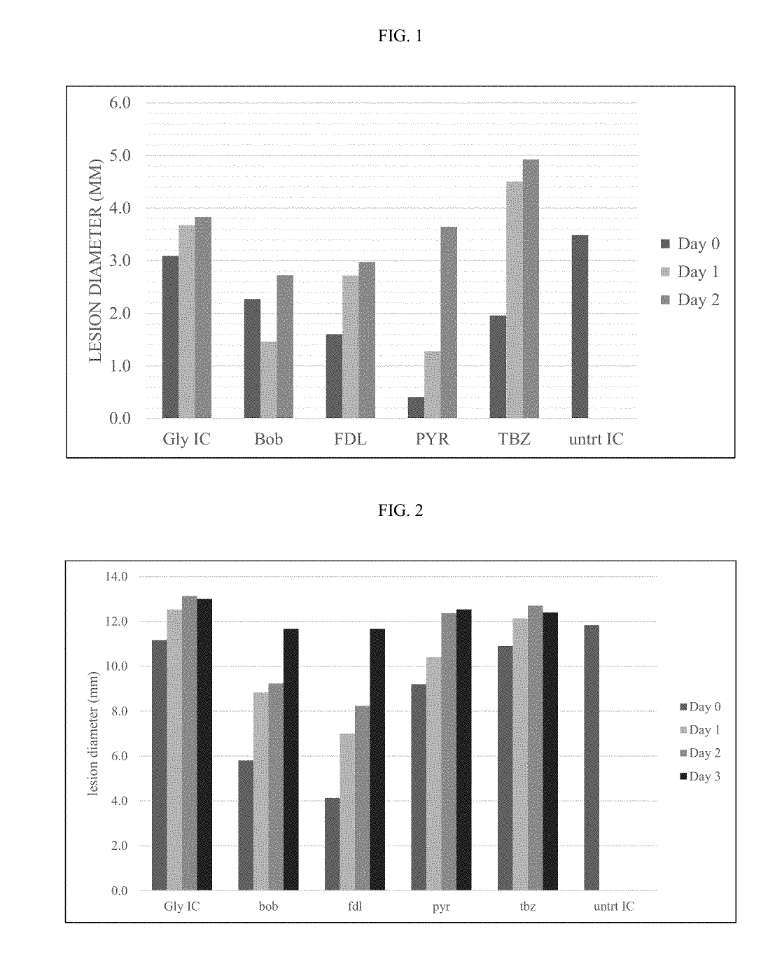

Finally, inoculated fruit cohorts treated with fungicide on Days 2 or 3 where returned to the control chamber on Days 3 or 4 and stored there for at least 12 hours (e.g., approximately 12-36 hours) until their fungal lesions were measured on Days 3 or 4 (see Table 2). The outcome of this experiment for Golden Delicious apples is summarized in Table 3 and FIG. 1.

The results demonstrate that rapid treatment of Golden Delicious apples on Days 0-2 with benzoxaborole (BOB) did not show a consistent increase in inhibition of fungal growth or any significant difference when compared to the inhibition of fungal growth observed for the untreated negative control apples or the propylene glycol-inoculated negative control apples (see Table 3 and FIG. 1). While rapid or early treatment with fludioxonil (FDL) on Days 0-1 (e.g., lesion sizes of 1.6 mm and 2.7 mm, respectively) showed greater inhibition of fungal growth of Penicillium and Botrytis lesions (averaged together) on Golden Delicious apples as compared to the untreated negative control apples (e.g., about 3.4 mm), the propylene glycol-inoculated negative control apples (e.g., 3.1 mm and 3.7 mm, respectively), and Golden Delicious apples treated with fludioxonil (FDL) on Day 2 (e.g., 3.0 mm), these differences were not significant.

However, these data results also demonstrate that rapid treatment with pyrimethanil (PYR) on Day 0 and Day 1 significantly inhibited fungal growth of Penicillium and Botrytis lesions (averaged together) on Golden Delicious apples to 0.4 mm and 1.3 mm, respectively, as compared to the untreated negative control apples having lesions measuring about 3.4 mm, and the propylene glycol-inoculated negative control apples, which had lesions measuring 3.1 mm and 3.7 mm, respectively (see Table 3 and FIG. 1). Importantly, the data also shows that rapid or early treatment of inoculated apples with pyrimethanil (PYR) on Day 0 and Day 1 significantly inhibited the average fungal growth of Penicillium and Botrytis lesions (averaged together) on Golden Delicious apples to 0.4 mm and 1.3 mm, respectively, as compared to lesions measuring 3.6 mm observed on inoculated apples treated with pyrimethanil (PYR) on Day 2 (see Table 3 and FIG. 1). Accordingly, these data demonstrate that early or rapid treatment (e.g., on Days 0 and 1) of Golden Delicious apples with pyrimethanil (PYR) is more efficacious in inhibiting fungal growth than later treatment with pyrimethanil (e.g., on Day 2).

These data results also demonstrate that rapid treatment with thiabendazole (TBZ) on Day 0 significantly inhibited fungal growth of Penicillium and Botrytis lesions (averaged together) on Golden Delicious apples to 2.0 mm, as compared to the untreated negative control apples having lesions measuring about 3.4 mm, and the propylene glycol-inoculated control apples, which had lesions measuring 3.1 mm on Day 0 (see Table 3 and FIG. 1). Importantly, the data also shows that rapid or early treatment of inoculated apples with thiabendazole (TBZ) on Day 0 significantly inhibited the average fungal growth of Penicillium and Botrytis lesions (averaged together) on Golden Delicious apples to 2.0 mm, as compared to lesions observed on inoculated apples treated with thiabendazole (TBZ) measuring 4.5 mm and 4.9 mm on Day 1 and Day 2, respectively (see Table 3 and FIG. 1). Accordingly, this data demonstrates that early or rapid treatment (e.g., on Day 0) of Golden Delicious apples with thiabendazole (TBZ) is more efficacious in inhibiting fungal growth than later treatment with thiabendazole (e.g., on Days 1 and 2).

Ultimately, these data demonstrate that the present method comprising a rapid or early treatment (e.g., Days 0-1) of a fungicide (e.g., pyrimethanil, thiabendazole, and fludioxonil) was efficacious to inhibit antimicrobial growth of fungal pathogens on Golden Delicious apples as compared to a later treatment of fungicide (e.g., Day 2). These results were unexpected.

TABLE 3

Pencillium and Botrytis fungal lesion size on
Golden Delicious Apples

| | | | | Fungal Lesion |
|---|---|---|---|---|
| | Fungicide | | | Diameter |
| Treatment | Fog Day | | | (mm) |
| BOB | 0 | A | | 2.3 |
| BOB | 1 | A | | 1.5 |
| BOB | 2 | A | | 2.7 |
| FDL | 0 | A | | 1.6 |
| FDL | 1 | A | | 2.7 |
| FDL | 2 | A | | 3.0 |
| Gly1C | 0 | A | | 3.1 |
| Gly1C | 1 | A | | 3.7 |
| Gly1C | 2 | A | | 3.8 |
| PYR | 0 | | B | 0.4 |
| PYR | 1 | | B | 1.3 |
| PYR | 2 | A | | 3.6 |
| TBZ | 0 | | B | 2.0 |
| TBZ | 1 | A | | 4.5 |
| TBZ | 2 | A | | 4.9 |

Both Penicillium expansum and Botrytis cinerea inoculation lesion sizes were averaged

### Example 2: Rapidity of Fungicide Treatment of Botrytis Growth Inhibition on Red Delicious Apples

This experiment was conducted exactly the same as described above in Example 1 unless noted otherwise. For example, instead of Golden Delicious apples, this experiment was performed on Red Delicious apples, which are harvested later in the season than Golden Delicious apples. Freshly harvested Red Delicious apples were wounded on the left and right side with Penicillium and Botrytis fungal pathogens, respectively. After inoculation, the apples remained at 20° C. throughout the remainder of the experimental trial to measure growth of the Botrytis fungal pathogen. Inoculated fruits were separated in preparation for an initial trial which comprised three replicates of 10-fruit cohorts totaling 5.5 kg of Red Delicious apples, respectively (see Table 1).

In this trial, replicate cohorts of Red Delicious apples were fog treated with 250 μL of the benzoxaborole (BOB) solution, 620 μL of the thiabendazole (TBZ) solution, 410 μL of the pyrimethanil (PYR) solution, or 250 μL of the fludioxonil (FDL) solution, respectively (see Table 1). The fungicide fogging treatment was applied to the Red Delicious apples in the sealed treatment chamber comprising a volume of 1.1 m³ such that the final concentration of active ingredient (“ai”) of each fungicide applied to the Red Delicious apples during the trial was 4.6 mg/kg of benzoxaborole (BOB), 11.2 mg/kg of thiabendazole (TBZ) solution, 11.8 mg/kg of pyrimethanil (PYR) solution, and 4.6 mg/kg of fludioxonil (FDL), respectively (see Table 1).

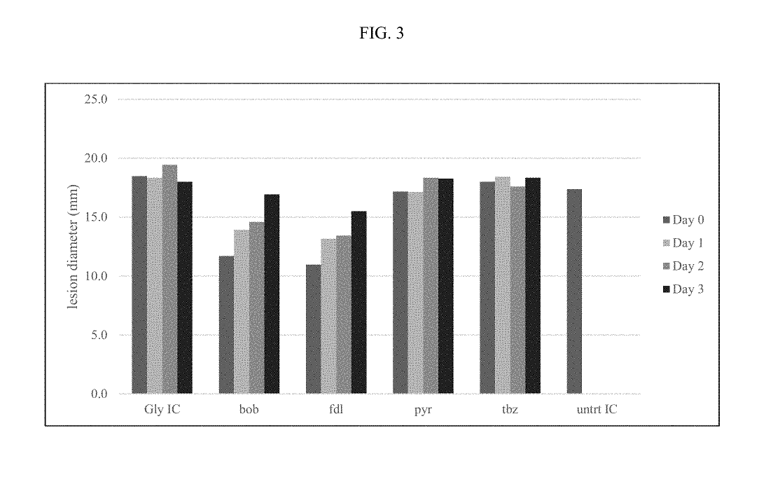

After 24 hours of fungicide treatment in the sealed chamber at 20° C., treated apples were returned back to the closed, controlled environment for storage. As described in Example 1, storage of treated Red Delicious apples occurred for at least 12 hours and for up to approximately 72 hours until Day 4 when fungal lesions on the treated Red Delicious apples were measured (see Table 2). The outcome of this experiment for Red Delicious apples is summarized in Table 4 and FIG. 2.

The data results demonstrate that rapid treatment with benzoxaborole (BOB) on Day 0 significantly inhibited fungal growth of Botrytis cinerea lesions on Red Delicious apples to 5.8 mm, as compared to the untreated negative control apples having lesions measuring about 11.8 mm, and the propylene glycol-inoculated negative control apples, which had lesions measuring 11.2 mm on Day 0 (see Table 4 and FIG. 2). In addition, these results show that rapid treatment with benzoxaborole (BOB) on Days 1 and 2 significantly inhibited fungal growth of Botrytis cinerea lesions on Red Delicious apples to 8.8 mm and 9.2 mm, respectively, as compared to the untreated negative control apples having lesions measuring about 11.8 mm, and the propylene glycol-inoculated negative control apples, which had lesions measuring 12.5 mm and 13.1 mm on Days 1 and 2, respectively (see Table 4 and FIG. 2).

Importantly, these data also show that rapid or early treatment of inoculated Red Delicious apples with benzoxaborole (BOB) on Day 0 significantly inhibited the average fungal growth of Botrytis cinerea lesions on Red Delicious to 5.8 mm as compared to lesions measuring 8.8 mm, 9.2 mm, and 11.7 mm as observed on inoculated apples treated with benzoxaborole (BOB) on Days 1, 2, and 3, respectively (see Table 4 and FIG. 2). Moreover, the data shows that inhibition of the average Botrytis cinerea lesions on Red Delicious apples measuring 8.8 mm and 9.2 mm on Days 1 and 2, respectively, was significantly different than the 11.7 mm lesions observed on apples treated on Day 3. Accordingly, these data demonstrate that early or rapid treatment (e.g., on Days 0-2) of Red Delicious apples with benzoxaborole (BOB) is more efficacious in inhibiting Botrytis cinerea fungal growth than later treatment with benzoxaborole (e.g., on Day 3).

Similarly, the data results demonstrate that rapid treatment with fludioxonil (FDL) on Day 0 significantly inhibited fungal growth of Botrytis cinerea lesions on Red Delicious apples to 4.1 mm, as compared to the untreated negative control apples having lesions measuring about 11.8 mm, and the propylene glycol-inoculated negative control apples, which had lesions measuring 11.2 mm on Day 0 (see Table 4 and FIG. 2). In addition, these results show that rapid treatment with fludioxonil (FDL) on Days 1 and 2 significantly inhibited fungal growth of Botrytis cinerea lesions on Red Delicious apples to 7.0 mm and 8.2 mm, respectively, as compared to the untreated negative control apples having lesions measuring about 11.8 mm, and the propylene glycol-inoculated negative control apples, which had lesions measuring 12.5 mm and 13.1 mm on Days 1 and 2, respectively (see Table 4 and FIG. 2).

Importantly, the data also shows that rapid or early treatment of inoculated Red Delicious apples with fludioxonil (FDL) on Day 0 significantly inhibited the average fungal growth of Botrytis cinerea lesions on Red Delicious apples to 4.1 mm as compared to lesions measuring 7.0 mm, 8.2 mm, and 11.7 mm as observed on inoculated Red Delicious apples treated with fludioxonil (FDL) on Days 1, 2, and 3, respectively (see Table 4 and FIG. 2). Moreover, the data shows that inhibition of the average Botrytis cinerea lesions on Red Delicious apples measuring 7.0 mm and 8.2 mm on Days 1 and 2, respectively, was significantly different than the 11.7 mm lesions measured on Day 3. Accordingly, these data demonstrate that early or rapid treatment (e.g., on Days 0-2) of Red Delicious apples with fludioxonil (FDL) is more efficacious in inhibiting Botrytis cinerea fungal growth than later treatment fludioxonil (e.g., on Day 3).

These data results also demonstrate that rapid treatment with pyrimethanil (PYR) on Day 0 and Day 1 significantly inhibited fungal growth of Botrytis cinerea lesions on Red Delicious apples to 9.2 mm and 10.4 mm, respectively, as compared to the untreated negative control apples having lesions measuring about 11.8 mm, and the propylene glycol-inoculated negative control apples, which had lesions measuring 11.2 mm and 12.5 mm on Days 0 and 1, respectively (see Table 4 and FIG. 2). In addition, these results show that rapid treatment with pyrimethanil (PYR) on Days 2 and 3 inhibited fungal growth of Botrytis cinerea lesions on Red Delicious apples to 12.4 mm and 12.5 mm, respectively, as compared to the untreated negative control apples having lesions measuring about 11.8 mm, and the propylene glycol-inoculated negative control apples, which had lesions measuring 13.1 mm and 13.0 mm on Days 2 and 3, respectively (see Table 4 and FIG. 2).

Importantly, the data also shows that rapid or early treatment of inoculated Red Delicious apples with pyrimethanil (PYR) on Days 0 and 1 significantly inhibited the average fungal growth of Botrytis cinerea lesions on Red Delicious apples to 9.2 mm and 10.4 mm, respectively, as compared to lesions measuring 12.4 mm and 12.5 mm as observed on inoculated Red Delicious apples treated with pyrimethanil (PYR) on Days 2 and 3, respectively (see Table 4 and FIG. 2). Accordingly, these data demonstrate that early or rapid treatment (e.g., on Days 0 and 1) of Red Delicious apples with pyrimethanil (PYR) is more efficacious in inhibiting Botrytis cinerea fungal growth than later treatment pyrimethanil (e.g., on Days 2 and 3).

These data results also demonstrate that rapid treatment with thiabendazole (TBZ) on Day 0 significantly inhibited fungal growth of Botrytis cinerea lesions on Red Delicious apples to 10.9 mm, as compared to the untreated negative control apples having lesions measuring about 11.8 mm, and the propylene glycol-inoculated negative control apples, which had lesions measuring 11.2 mm on Day 0 (see Table 4 and FIG. 2). Importantly, the data also shows that rapid or early treatment of inoculated Red Delicious apples with thiabendazole (TBZ) on Day 0 significantly inhibited the average fungal growth of Botrytis cinerea lesions on Red Delicious apples to 10.9 mm, as compared to lesions measuring 12.1 mm, 12.7 mm, and 12.4 mm as observed on inoculated Red Delicious apples treated with thiabendazole (TBZ) on Days 1, 2 and 3, respectively (see Table 4 and FIG. 2). Accordingly, these data demonstrate that early or rapid treatment (e.g., on Day 0) of Red Delicious apples with thiabendazole (TBZ) is more efficacious in inhibiting Botrytis cinerea fungal growth than later treatment pyrimethanil (e.g., on Days 1, 2, and 3). These results were unexpected.

TABLE 4

| | Botrytis cinerea lesion size on | | | | |
|---|---|---|---|---|---|
| | Red Delicious Apples | | | | |
| | | | | | Fungal Lesion |
| | Fungicide | | | | Diameter |
| Treatment | Fog Day | | | | (mm) |
| BOB | 0 | | | C | 5.8 |
| BOB | 1 | | B | | 8.8 |
| BOB | 2 | | B | | 9.2 |
| BOB | 3 | A | | | 11.7 |
| FDL | 0 | | | C | 4.1 |
| FDL | 1 | | B | | 7.0 |
| FDL | 2 | | B | | 8.2 |
| FDL | 3 | A | | | 11.7 |
| GLY1C | 0 | | B | | 11.2 |
| GLY1C | 1 | | | | 12.5 |
| GLY1C | 2 | A | | | 13.1 |
| GLY1C | 3 | A | | | 13.0 |
| PYR | 0 | | B | | 9.2 |
| PYR | 1 | | B | | 10.4 |
| PYR | 2 | A | | | 12.4 |
| PYR | 3 | A | | | 12.5 |
| TBZ | 0 | | B | | 10.9 |
| TBZ | 1 | A | B | | 12.1 |
| TBZ | 2 | A | | | 12.7 |
| TBZ | 3 | A | | | 12.4 |

### Example 3: Rapidity of Fungicide Treatment of Penicillium Growth Inhibition on Red Delicious Apples

This experiment was conducted exactly the same as described above in Example 2 unless noted otherwise. In particular, freshly harvested Red Delicious apples were wounded on the left and right side with Penicillium and Botrytis fungal pathogens, respectively. After inoculation, the apples remained at 20° C. throughout the remainder of the experimental trial to measure growth of the Penicillium fungal pathogen.

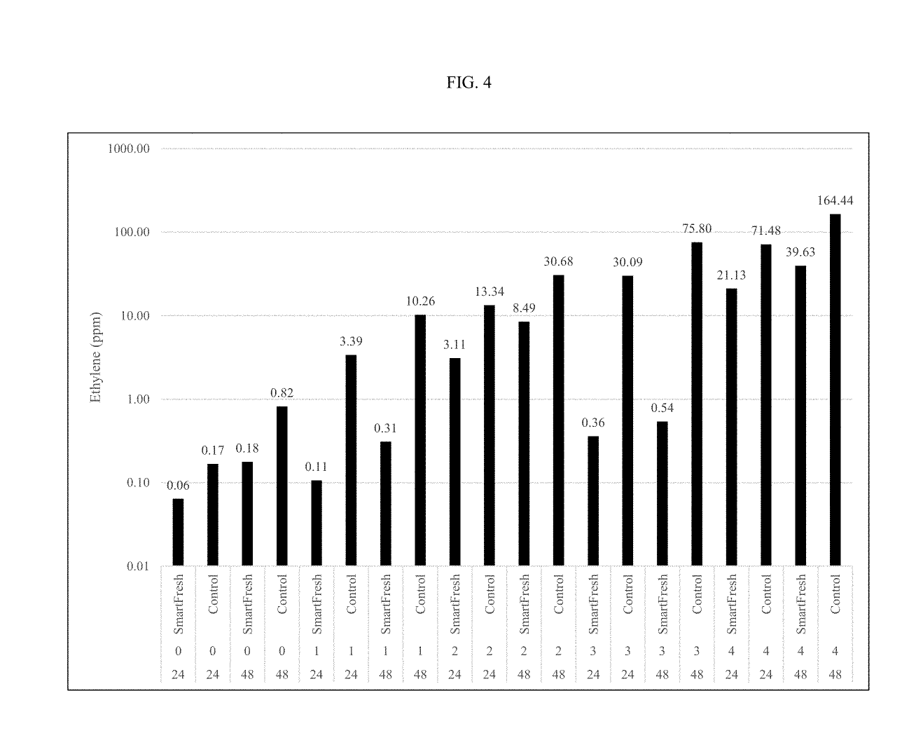

The results demonstrate that rapid treatment of Red Delicious apples on Days 0-3 with pyrimethanil (PYR) resulted in Penicillium expansum lesion sizes ranging from 17.1-18.3 mm (see Table 5 and FIG. 3). Penicillium expansum lesions that were treated with thiabendazole (TBZ) resulted in sizes ranging from 17.6-18.4 mm.

Neither treatments comprising pyrimethanil (PYR) nor thiabendazole (TBZ) showed a consistent increase in inhibition of Penicillium expansum fungal growth or any significant difference when compared to the inhibition of fungal growth observed for the untreated negative control apples (e.g., 17.5 mm) or the propylene glycol-inoculated negative control apples having lesion sizes ranging from 18.0-19.4 mm (see Table 5 and FIG. 3).

However, the data results also demonstrate that rapid treatment with benzoxaborole (BOB) on Day 0 significantly inhibited fungal growth of Pencillium expansum lesions on Red Delicious apples to 11.7 mm, as compared to the untreated negative control apples having lesions measuring about 17.5 mm, and the propylene glycol-inoculated negative control apples, which had lesions measuring 18.5 mm on Day 0 (see Table 5 and FIG. 3). In addition, these results show that rapid treatment with benzoxaborole (BOB) on Days 1 and 2 significantly inhibited fungal growth of Pencillium expansum lesions on Red Delicious apples to 13.9 mm and 14.6 mm, respectively, as compared to the untreated negative control apples having lesions measuring about 17.5 mm, and the propylene glycol-inoculated negative control apples, which had lesions measuring 18.3 mm and 19.4 mm on Days 1 and 2, respectively (see Table 5 and FIG. 3).

Importantly, these data also show that rapid or early treatment of inoculated Red Delicious apples with benzoxaborole (BOB) on Day 0 significantly inhibited the average fungal growth of Pencillium expansum lesions on Red Delicious to 11.7 mm as compared to lesions measuring 13.9 mm, 14.6 mm, and 16.9 mm as observed on inoculated apples treated with benzoxaborole (BOB) on Days 1, 2, and 3, respectively (see Table 5 and FIG. 3). Moreover, the data shows that inhibition of the average Pencillium expansum lesions on Red Delicious apples measuring 13.9 mm and 14.6 mm on Days 1 and 2, respectively, was significantly different than the 16.9 mm lesions observed on apples treated on Day 3. Accordingly, these data demonstrate that early or rapid treatment (e.g., on Days 0-2) of Red Delicious apples with benzoxaborole (BOB) is more efficacious in inhibiting Pencillium expansum fungal growth than later treatment with benzoxaborole (e.g., on Day 3).

Similarly, the data results demonstrate that rapid treatment with fludioxonil (FDL) on Day 0 significantly inhibited fungal growth of Pencillium expansum lesions on Red Delicious apples to 11.0 mm, as compared to the untreated negative control apples having lesions measuring about 17.5 mm, and the propylene glycol-inoculated negative control apples, which had lesions measuring 18.5 mm on Day 0 (see Table 5 and FIG. 3). In addition, these results show that rapid treatment with fludioxonil (FDL) on Days 1 and 2 significantly inhibited fungal growth of Pencillium expansum lesions on Red Delicious apples to 13.2 mm and 13.4 mm, respectively, as compared to the untreated negative control apples having lesions measuring about 17.5 mm, and the propylene glycol-inoculated negative control apples, which had lesions measuring 18.3 mm and 19.4 mm on Days 1 and 2, respectively (see Table 5 and FIG. 3).

TABLE 5

| | Penicillium expansum lesion size on | | | | |
|---|---|---|---|---|---|
| | Red Delicious Apples | | | | |
| | | | | | Fungal Lesion |
| | Fungicide | | | | Diameter |
| Treatment | Fog Day | | | | (mm) |
| BOB | 0 | | | C | 11.7 |
| BOB | 1 | | B | | 13.9 |
| BOB | 2 | | B | | 14.6 |
| BOB | 3 | A | | | 16.9 |
| FDL | 0 | | | C | 11.0 |
| FDL | 1 | | B | | 13.2 |
| FDL | 2 | | B | | 13.4 |
| FDL | 3 | A | | | 15.5 |
| GLY1C | 0 | A | | | 18.5 |
| GLY1C | 1 | A | | | 18.3 |
| GLY1C | 2 | A | | | 19.4 |
| GLY1C | 3 | A | | | 18.0 |
| PYR | 0 | A | | | 17.2 |
| PYR | 1 | A | | | 17.1 |
| PYR | 2 | A | | | 18.3 |
| PYR | 3 | A | | | 18.3 |
| TBZ | 0 | A | | | 18.0 |
| TBZ | 1 | A | | | 18.4 |
| TBZ | 2 | A | | | 17.6 |
| TBZ | 3 | A | | | 18.3 |

Importantly, the data also shows that rapid or early treatment of inoculated Red Delicious apples with fludioxonil (FDL) on Day 0 significantly inhibited the average fungal growth of Pencillium expansum lesions on Red Delicious apples to 11.0 mm as compared to lesions measuring 13.2 mm, 13.4 mm, and 15.5 mm as observed on inoculated Red Delicious apples treated with fludioxonil (PDL) on Days 1, 2, and 3, respectively (see Table 5 and FIG. 3). Moreover, the data shows that inhibition of the average Pencillium expansum lesions on Red Delicious apples measuring 13.2 mm and 13.4 mm on Days 1 and 2, respectively, was significantly different than the 15.5 mm lesions measured on Day 3. Accordingly, these data demonstrate that early or rapid treatment (e.g., on Days 0-2) of Red Delicious apples with fludioxonil (FDL) is more efficacious in inhibiting Pencillium expansum fungal growth than later treatment fludioxonil (e.g., on Day 3). These results were unexpected.

### Example 4: Rapidity of Cyclopropene Treatment on Ethylene Production of Golden Delicious Apples

Freshly harvested Golden Delicious apples were separated in preparation for an experimental trial that comprised three replicates of 60-fruit cohorts each totaling 30.6 kg of Golden Delicious apples (see Table 6). Immediately after harvest, the fruit cohorts were each treated for 24 hours in a sealed chamber at 20° C. with a concentration of SmartFresh 1-MCP (see Table 6). Different fruit cohorts were treated with SmartFresh for 24 hours beginning on Days 0, 1, 2, 3, and/or 4 after harvest (see Table 7).

More specifically, each fruit cohort of this trial was treated a single time for 24 hours at 20° C. with a SmartFresh solution comprising 3.8% of active 1-MCP (see Table 6). In particular, the SmartFresh solution was applied to the Golden Delicious apples in the sealed treatment chamber comprising a volume of 28.4 m³ such that the final concentration of active 1-MCP applied to the apples during the trial was 1.8 g of 1-MCP (see Table 6).

After completion of the 1-MCP treatment, treated apples were removed from the sealed treatment chamber and stored at 20° C. in a closed, controlled environment for an additional 24-48 hours until ethylene production was measured (see Table 7). For example, fruit treated with 1-MCP on Day 0, were returned from the sealed treatment chamber to the controlled environment on Day 1 and stored there for at least 24-48 hours until ethylene production was measured. Golden Delicious apples treated on Day 1, were returned from the sealed treatment chamber to the controlled environment on Day 2, and stored there for at least 24-48 hours until ethylene production was measured. Similarly, Golden Delicious apples treated on Days 2-4, were returned from the sealed treatment chamber to the controlled environment on Days 3-5, respectively, and stored there for at least 24-48 hours until ethylene production was measured. Once measured, the ethylene production of 1-MCP-treated Golden Delicious apples was compared to ethylene production of untreated control apples (see FIG. 4). The outcome of this experiment for Golden Delicious apples is summarized in Table 8 and FIG. 4

TABLE 6

| | Golden Delicious Trial | | Red Delicious Trial | |
|---|---|---|---|---|
| Treatment | Control | SmartFresh | Control | SmartFresh |
| Fruit weight (kg) | 30.6 | 30.6 | 33.0 | 33.0 |
| Temperature (° C.) | 20 | 20 | 20 | 20 |
| Treatment volume | 28.4 | 28.4 | 28.4 | 28.4 |
| (meters³) | | | | |
| SmartFresh 3.8% active | 1.8 | 1.8 | 1.8 | 1.8 |
| (grams) | | | | |
| Treatment duration | 24 | 24 | 24 | 24 |
| (hours) | | | | |

TABLE 7

| | Day 0 | Day 1 | Day 2 | Day 3 | Day 4 | Day 5 | Day 6 | Day 7 |
|---|---|---|---|---|---|---|---|---|
| SmartFresh | All Fruits- | Day 0 | Day 0 Fruit | Day 0 Fruit | Day 1 Fruit | Day 2 Fruit | Day 3 Fruit | Day 4 Fruit |
| Experiment | harvested | Fruit | Measured | Measured | Measured | Measured | Measured | Measured |
| Treatment | Day 0 Fruit | Stored | (24 hr) | (48 hr) | (48 hr) | (48 hr) | (48 hr) | (48 hr) |
| Regimen for | Treated | Day 1 | Day 1 Fruit | Day 1 Fruit | Day 2 Fruit | Day 3 Fruit | Day 4 Fruit | |
| Red and | | Fruit | Stored | Measured | Measured | Measured | Measured | |
| Golden | | Treated | Day 2 Fruit | (24 hr) | (24 hr) | (24 hr) | (24 hr) | |
| Delicious | | | Treated | Day 2 Fruit | Day 3 Fruit | Day 4 Fruit | | |
| Apples | | | | Stored | Stored | Stored | | |
| | | | | Day 3 Fruit | Day 4 Fruit | | | |
| | | | | Treated | Treated | | | |

The results demonstrate that rapid or early treatment of 1-MCP was efficacious to inhibit ethylene production in Golden Delicious apples as compared to later 1-MCP treatment of Golden Delicious apples. More specifically, Table 8 and FIG. 4 show that ethylene produced by Golden Delicious apples at 24 hours after treatment with SmartFresh 1-MCP on Day 0 (0.06 ppm) was significantly reduced from the amount of ethylene produced by Golden Delicious apples at 24 hours by untreated apples (0.17 ppm), as well as the amount of ethylene produced by Golden Delicious apples at 48 hours after treatment with SmartFresh 1-MCP on Day 0 (0.18 ppm) or no 1-MCP treatment at all (0.82 ppm). Interestingly, the ethylene produced by the untreated Golden Delicious apples at 24 hours (0.17 ppm) was similar to the ethylene produced by the apples at 48 hours after treatment with SmartFresh 1-MCP on Day 0 (0.18 ppm).

A similar trend was observed with Golden Delicious apples first treated with SmartFresh 1-MCP on Day 1 (see Table 8 and FIG. 4). For example, ethylene produced by Golden Delicious apples at 24 hours after treatment with SmartFresh 1-MCP on Day 1 (0.11 ppm) was significantly reduced from the amount of ethylene produced by Golden Delicious apples at 24 hours by untreated apples (3.39 ppm). Similarly, ethylene produced by Golden Delicious apples at 48 hours after treatment with SmartFresh 1-MCP on Day 1 (0.31 ppm) was significantly reduced from the amount of ethylene produced by Golden Delicious apples at 48 hours by untreated apples (10.26 ppm). However, unlike the apples treated on Day 0, Golden Delicious apples treated with 1-MCP on Day 1 produced comparable amounts of ethylene at 24 hours (0.11 ppm) and at 48 hours (0.31 ppm) after treatment, although these concentrations of ethylene were increased from the amount of ethylene produced by apples treated on Day 0 at 24 hours (0.06 ppm) and 48 hours (0.18 ppm), respectively.

Further referring to Table 8 and FIG. 4, ethylene produced by Golden Delicious apples at 24 hours after treatment with SmartFresh 1-MCP on Day 2 (3.11 ppm) was also significantly reduced from the amount of ethylene produced by Golden Delicious apples at 24 hours by untreated apples (13.34 ppm). Similarly, ethylene produced by Golden Delicious apples at 48 hours after treatment with SmartFresh 1-MCP on Day 2 (8.49 ppm) was significantly reduced from the amount of ethylene produced by Golden Delicious apples at 48 hours by untreated apples (30.68 ppm). Similar to the trend observed for the Day 0 apples, the ethylene produced by the untreated Golden Delicious apples at 24 hours after Day 1 (3.39 ppm) was similar to the ethylene produced by the apples at 24 hours after treatment with SmartFresh 1-MCP on Day 2 (3.11 ppm).

Ethylene produced by Golden Delicious apples at 24 hours after treatment with SmartFresh 1-MCP on Day 3 (0.36 ppm) was significantly reduced from the amount of ethylene produced by Golden Delicious apples at 24 hours by untreated apples (30.09 ppm). Similarly, ethylene produced by Golden Delicious apples at 48 hours after treatment with SmartFresh 1-MCP on Day 3 (0.54 ppm) was significantly reduced from the amount of ethylene produced by Golden Delicious apples at 48 hours by untreated apples (75.80 ppm). Interestingly, the ethylene production for Golden Delicious apples treated on Day 3 showed the most inhibition at both 24 hours (0.36 ppm) and 48 hours (0.54 ppm) after 1-MCP treatment as compared to the corresponding untreated control apples having 30.09 ppm and 75.8 ppm of ethylene produced at 24 hours and 48 hours, respectively (see Table 8 and FIG. 4).

Finally, Table 8 and FIG. 4 demonstrate that ethylene produced by Golden Delicious apples at 24 hours after treatment with SmartFresh 1-MCP on Day 4 (21.13 ppm) was significantly reduced from the amount of ethylene produced by Golden Delicious apples after 24 hours by untreated apples (71.48 ppm). Similarly, ethylene produced by Golden Delicious apples at 48 hours after treatment with SmartFresh 1-MCP on Day 4 (39.63 ppm) was significantly reduced from the amount of ethylene produced by Golden Delicious apples at 48 hours by untreated apples (164.44 ppm). Accordingly, these data demonstrate that early or rapid treatment (e.g., on Days 0-3) of Golden Delicious apples with 1-MCP is more efficacious in inhibiting ethylene production than later treatment of 1-MCP on Golden Delicious apples (e.g., on Day 4). These results were unexpected.

TABLE 8
Golden Delicious

| Hours after MCP | Treatment | Ethylene |
|---|---|---|
| 24 | Day 0 SF | 0.06 |
| 24 | Day 0 Control | 0.17 |
| 48 | Day 0 SF | 0.18 |
| 48 | Day 0 Control | 0.82 |
| 24 | Day 1 SF | 0.11 |
| 24 | Day 1 Control | 3.39 |
| 48 | Day 1 SF | 0.31 |
| 48 | Day 1 Control | 10.26 |
| 24 | Day 2 SF | 3.11 |
| 24 | Day 2 Control | 13.34 |
| 48 | Day 2 SF | 8.49 |
| 48 | Day 2 Control | 30.68 |
| 24 | Day 3 SF | 0.36 |
| 24 | Day 3 Control | 30.09 |
| 48 | Day 3 SF | 0.54 |
| 48 | Day 3 Control | 75.8 |
| 24 | Day 4 SF | 21.13 |
| 24 | Day 4 Control | 71.48 |
| 48 | Day 4 SF | 39.63 |
| 48 | Day 4 Control | 164.44 |

### Example 5: Rapidity of Cyclopropene Treatment on Ethylene Production of Red Delicious Apples

This experiment was conducted exactly the same as described above in Example 4 unless noted otherwise. For example, instead of Golden Delicious apples, this experiment was performed on Red Delicious apples, which are harvested later in the season than Golden Delicious apples. Freshly harvested Red Delicious apples were separated in preparation for an experimental trial that comprised three replicates of 60-fruit cohorts each totaling 33.0 kg of Red Delicious apples (see Table 6). Immediately after harvest, the fruit cohorts were each treated for 24 hours in a sealed chamber at 20° C. with a concentration of SmartFresh 1-MCP (see Table 6). Different fruit cohorts were treated with SmartFresh for 24 hours beginning on Days 0, 1, 2, 3, and/or 4 after harvest (see Table 7).

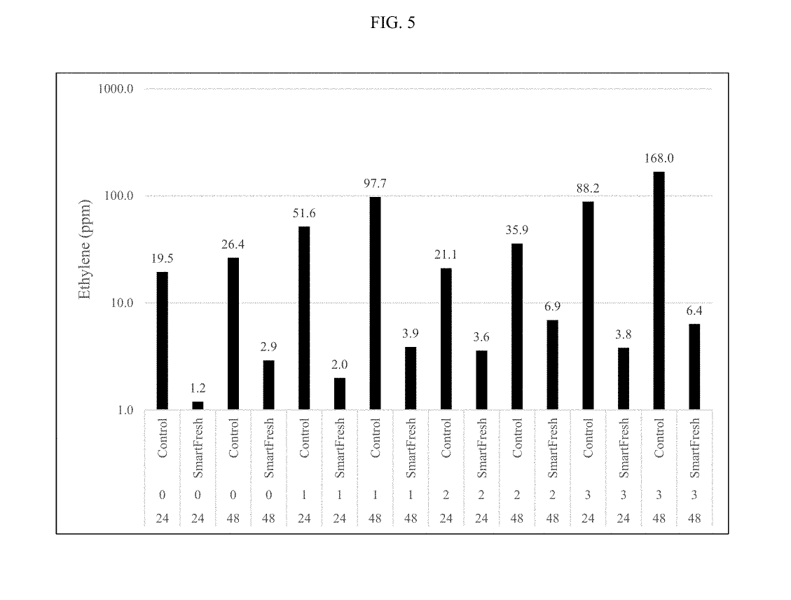

After completion of the 1-MCP treatment, treated apples were removed from the sealed treatment chamber and stored at 20° C. in a closed, controlled environment for an additional 24-48 hours until ethylene production was measured (see Table 7). Once measured, the ethylene production of 1-MCP-treated Red Delicious apples was compared to ethylene production of untreated control apples (see FIG. 6). The outcome of this experiment for Red Delicious apples is summarized in Table 9 and FIG. 5.

The results demonstrate that rapid or early treatment of 1-MCP was efficacious to inhibit ethylene production in Red Delicious apples as compared to later 1-MCP treatment of Red Delicious apples. More specifically, Table 9 and FIG. 5 show that ethylene produced by Red Delicious apples at 24 hours after treatment with SmartFresh 1-MCP on Day 0 (1.2 ppm) was significantly reduced from the amount of ethylene produced by Red Delicious apples at 24 hours by untreated apples (19.5 ppm), as well as the amount of ethylene produced by Red Delicious apples at 48 hours after treatment with SmartFresh 1-MCP on Day 0 (2.9 ppm) or no 1-MCP treatment at all (26.4 ppm).

A similar trend was observed with Red Delicious apples first treated with SmartFresh 1-MCP on Day 1 (see Table 9 and FIG. 5). For example, ethylene produced by Red Delicious apples at 24 hours after treatment with SmartFresh 1-MCP on Day 1 (2.0 ppm) was significantly reduced from the amount of ethylene produced by Red Delicious apples at 24 hours by untreated apples (51.6 ppm). Similarly, ethylene produced by Red Delicious apples at 48 hours after treatment with SmartFresh 1-MCP on Day 1 (3.9 ppm) was significantly reduced from the amount of ethylene produced by Red Delicious apples at 48 hours by untreated apples (97.7 ppm).

Further referring to Table 9 and FIG. 5, ethylene produced by Red Delicious apples at 24 hours after treatment with SmartFresh 1-MCP on Day 2 (3.6 ppm) was also significantly reduced from the amount of ethylene produced by Red Delicious apples at 24 hours by untreated apples (21.1 ppm). Similarly, ethylene produced by Red Delicious apples at 48 hours after treatment with SmartFresh 1-MCP on Day 2 (6.9 ppm) was significantly reduced from the amount of ethylene produced by Red Delicious apples at 48 hours by untreated apples (35.9 ppm).

Further, ethylene produced by Red Delicious apples at 24 hours after treatment with SmartFresh 1-MCP on Day 3 (3.8 ppm) was significantly reduced from the amount of ethylene produced by Red Delicious apples at 24 hours by untreated apples (88.2 ppm). Similarly, ethylene produced by Red Delicious apples at 48 hours after treatment with SmartFresh 1-MCP on Day 3 (6.4 ppm) was significantly reduced from the amount of ethylene produced by Red Delicious apples at 48 hours by untreated apples (168.0 ppm).

Interestingly, the ethylene production for Red Delicious apples measured 48 hours after being treated with 1-MCP on Day 1 (3.9 ppm) showed comparable inhibition as compared to the ethylene production for Red Delicious apples measured 24 hours after being treated on Day 2 (3.6 ppm) and on Day 3 (3.8 ppm), respectively. Therefore, these data demonstrate that early or rapid treatment (e.g., on Days 0-2) of Red Delicious apples with 1-MCP is generally more efficacious in inhibiting ethylene production in Red Delicious apples than later treatment of 1-MCP on Red Delicious apples (e.g., on Day 3). These results were unexpected.

TABLE 9
Red Delicious

| Hours after MCP | Treatment | Ethylene |
|---|---|---|
| 24 | Day 0 Control | 19.5 |
| 24 | Day 0 SF | 1.2 |
| 48 | Day 0 Control | 26.4 |
| 48 | Day 0 SF | 2.9 |
| 24 | Day 1 Control | 51.6 |
| 24 | Day 1 SF | 2.0 |
| 48 | Day 1 Control | 97.7 |
| 48 | Day 1 SF | 3.9 |
| 24 | Day 2 Control | 21.1 |
| 24 | Day 2 SF | 3.6 |
| 48 | Day 2 Control | 35.9 |
| 48 | Day 2 SF | 6.9 |
| 24 | Day 3 Control | 88.2 |
| 24 | Day 3 SF | 3.8 |
| 48 | Day 3 Control | 168.0 |
| 48 | Day 3 SF | 6.4 |

The preceding description enables others skilled in the art to utilize the technology in various embodiments and with various modifications as are suited to the particular use contemplated. In accordance with the provisions of the patent statutes, the principles and modes of operation of this disclosure have been explained and illustrated in exemplary embodiments. Accordingly, the present invention is not limited to the particular embodiments described and/or exemplified herein.

It is intended that the scope of disclosure of the present technology be defined by the following claims. However, it must be understood that this disclosure may be practiced otherwise than is specifically explained and illustrated without departing from its spirit or scope. It should be understood by those skilled in the art that various alternatives to the embodiments described herein may be employed in practicing the claims without departing from the spirit and scope as defined in the following claims.

The scope of this disclosure should be determined, not only with reference to the above description, but should instead be determined with reference to the appended claims, along with the full scope of equivalents to which such claims are entitled. It is anticipated and intended that future developments will occur in the arts discussed herein, and that the disclosed compositions and methods will be incorporated into such future examples.

Furthermore, all terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary. It is intended that the following claims define the scope of the disclosure and that the technology within the scope of these claims and their equivalents be covered thereby. In sum, it should be understood that the disclosure is capable of modification and variation and is limited only by the following claim.

What is claimed is:

1. A method of co-treating plants or plant parts comprising:
placing the plants or plant parts in an enclosed space,
administering a co-treatment comprising a pesticide and a plant growth regulator to the plants or plant parts within the enclosed space, and
inhibiting plant pathogens and ethylene action of the plants or plant parts.

2. The method of claim 1, wherein the plants or plant parts comprise fruit.

3. The method of claim 1, wherein the plant growth regulator is selected from the group consisting of 1-MCP and diphenylamine.

4. The method of claim 1, wherein the pesticide is selected from the group consisting of pyrimethanil, fludioxonil, thiabendazole, imazalil, and benzoxaborole compounds.

5. The method of claim 3, wherein the 1-MCP is administered to the enclosed space as a gaseous composition.

6. The method of claim 1, wherein the pesticide is administered to the enclosed space as a fog.

7. The method of claim 6, wherein the fog is administered inside the enclosed space.

8. The method of claim 6, wherein the enclosed space is not ventilated.

9. The method of claim 1, wherein the pesticide and the plant growth regulator are administered to the plants or plant parts in the enclosed space simultaneously.

10. The method of claim 1, wherein the pesticide and the plant growth regulator are administered to the plants or plant parts in the enclosed space concurrently.

11. The method of claim 1, wherein the pesticide is fludioxonil.

12. The method of claim 1, wherein the pesticide is benzoxaborole.

13. The method of claim 1, wherein the pesticide is pyrimethanil.

14. The method of claim 1, wherein the pesticide is thiabendazole.

15. The method of claim 6, wherein the fog comprises a plurality of microparticles.

16. The method of claim 15, wherein each microparticle of the plurality of microparticles have a size of about 2 microns or less.

17. The method of claim 15, wherein each microparticle of the plurality of microparticles has a size of about 1 micron or less.

18. A crop protection composition for treating plants or plant parts comprising:
a pesticide, wherein the pesticide is a fog,
wherein the fog comprises a plurality of microparticles, wherein each microparticle of the plurality of microparticles has a size of about 2 microns or less.

19. The crop protection composition of claim 18, wherein each microparticle of the plurality of microparticles has a size of about 1 micron or less.

20. The crop protection composition of claim 18, wherein each microparticle of the plurality of microparticles has a size that is less than 1 micron.
